(19) United States
(12) Patent Application Publication
(10) Pub. No.: US 2025/0317030 A1
(43) Pub. Date: Oct. 9, 2025

(54) AIRCRAFT PISTON ENGINE MAGNETO AND IGNITION SYSTEM

(71) Applicant: Champion Aerospace LLC, Liberty, SC (US)

(72) Inventors: Sean P. KEENAN, Anderson, SC (US); Thomas L. JUSTICE, Anderson, SC (US); James P. MULLENS, Iva, SC (US)

(21) Appl. No.: 19/245,096

(22) Filed: Jun. 20, 2025

Related U.S. Application Data
(63) Continuation-in-part of application No. 18/544,421, filed on Dec. 18, 2023.
(60) Provisional application No. 63/433,053, filed on Dec. 16, 2022.
(60) Provisional application No. 63/662,414, filed on Jun. 20, 2024.

(51) Int. Cl. H02K 11/00; H01F 38/12; H02J 50/10; H02K 1/22

(52) U.S. Cl. CPC H02K 11/0094; H01F 38/12; H02J 50/10; H02K 1/22

(57) ABSTRACT

An aircraft piston engine magneto having a magnetic rotor and an ignition circuit that includes a charging coil inductively coupled to magnetic poles of the rotor. The charging coil includes a plurality of power coils that are inductively powered off the magnetic rotor and that charge the ignition circuit during rotation of the rotor. One or more of the power coils are electronically utilized by the ignition circuit as a higher turn power coil when the rotor is running at low speeds and as a lower turn power coil when the rotor is running at higher speeds. The ignition circuit is a fully electronic ignition circuit that generates and distributes ignition pulses to the piston engine spark plugs using only non-mechanically actuated electrical components within the magneto.

### TECHNICAL FIELD

The present invention relates to magneto ignition systems for aircraft piston engines.

### BACKGROUND

A typical magneto for an aircraft piston engine ignition system includes all of the mechanical and electrical components needed to generate and timing the ignition pulses provided to the spark plugs via ignition leads. A significant advantage of magneto driven ignition systems is that once the engine is started, it can run without the magneto requiring any battery or other external electrical power source.

As shown diagrammatically in FIG. 26, most magnetos in use today have a permanent magnet rotor, also referred to as a magnetic rotor, that is driven from an external input rotating in sync with, and at the same speed as, the engine crankshaft, a primary coil used to store energy from the changing magnetic flux of the rotor during rotation, a secondary coil inductively coupled to the primary to provide a stepped up high voltage when the current through the primary is interrupted, a contact breaker to cause that primary current interruption, a camshaft with cam that mechanically opens and closes the contact breaker in synchronicity with the crankshaft angular position, and a distributor having a rotating switch terminal connected to the secondary to sequentially distribute the ignition pulses to the spark plugs in the different cylinders. Both the camshaft and distributor switch are rotated via the rotor such that the inputted mechanical rotation that drives the magneto is transferred through the rotor to the camshaft and distributor switch. This can be seen in FIGS. 27 and 28 for a typical magneto. The cam shaft is formed by the end of the rotor opposite its input end and this cam shaft includes a slot into which the cam is press-fitted and positioned axially to engage the movable breaker point of the contact breaker. The rotary switch of the distributor is run via meshed gears including a distributor drive gear assembled on the cam shaft above the cam, and a driven gear on which the rotary switch is mounted in the distributor. Such mechanically-functioning magnetos that include at least a cam driven contact breaker and distributor are referred to herein as mechanical magnetos.

In order to obtain proper timing of the sparks in each cylinder, the angular position of the rotor magnet poles must be set relative to the crankshaft cylinder TDC. And through gearing from the crankshaft, the angular position of the magnet poles once set is maintained, as is the rotary switch of the distributor via its gearing. However, in mechanical magnetos the physical wear on components from use in service can impact the actual timing of ignition pulses relative to TDC, especially for the cam and its contact breaker. As a result, this timing is usually checked and, if necessary, recalibrated to TDC every 100 hours of operation, with an internal inspection of the magneto and replacement of worn parts occurring every 500 hours. These checks and inspections increase the service and maintenance burden of the aircraft engine since they are much shorter intervals than the typical 2000 hour engine overhaul schedule.

Apart from calibration of the rotor angular position relative to TDC, there is also a need for basic adjustments in ignition timing. Unlike more complex internal combustion engines used in the automotive industry, the spark timing in a magneto-type aircraft piston engine is generally fixed (and not variable) relative to piston top dead center (TDC). For maximum efficiency at normal flight operating speeds, that fixed timing is set at about 20° before TDC (BTDC). However, at lower, startup speeds, this is too early in the cycle and results in cylinder ignition occurring during the compression stroke before TDC is reached. Thus, for slower engine speeds (e.g., <600 rpm), many magnetos include an impulse coupling connected between the permanent magnet rotor and its input drive. The impulse coupling includes one or more pawls designed for stop and release contact with a stop pin as the coupling rotates. This results in one or more pauses rotation of the rotor during each revolution while loading a coil spring that is released at the end of each pause to provide a high speed rotational return of the rotor. In this way, the rotor after pausing speeds up and catches up with the input drive, thereby generating sufficient flux in the magneto to fire the spark plugs. These pauses in rotation are created by interfering contact between one or more pawls of the impulse coupling and at least one stop pin on the magneto housing. At higher speeds the impulse coupling pawls move out of functional position due to the centripetal forces on them. This allows the rotor to run continuously at the same speed as the input drive. This input coupling is yet another mechanical component subject to wear that must be inspected (and parts replaced if needed) many times between the normal 2000 hour engine overhauls.

Retard contact breakers are used on some mechanical magnetos instead of impulse couplings. Although they have the advantage of reducing the mechanical wear issues of impulse couplings, they merely solve the ignition timing problem at slower engine speeds and do nothing to help the magneto generate sufficient electrical power to run the ignition. They therefore require aircraft battery power and a starting vibrator to generate pulses from the battery power that are fed into the magneto primary via the pilot's P-Lead. Because they require external power input to work, such retard breaker magnetos are not electrically self-starting, and have the same cam, camshaft, contact breakers (2 sets), and distributor mechanical issues of other conventional magnetos.

### SUMMARY

In accordance with one aspect of the invention, there is provided an aircraft piston engine magneto having a magnetic rotor and an ignition circuit that includes a charging coil inductively coupled to magnetic poles of the rotor, wherein the charging coil comprises a plurality of power coils that are inductively powered off the magnetic rotor and that charge the ignition circuit during rotation of the rotor, and wherein one or more of the power coils are electronically utilized by the ignition circuit as a higher turn power coil when the rotor is running at low speeds and as a lower turn power coil when the rotor is running at higher speeds.

In accordance with another aspect of the invention, there is provided a magneto comprising:
a housing;
a rotor assembly mounted in the housing and comprising a magnetic rotor and at least one bearing that supports the rotor for rotation in the housing about a rotational axis, the rotor assembly having a first end and a second end, with the rotor having a permanent magnet assembly located between the first and second ends, and with the rotor having a rotor arm fixed to the rotor at the second end of the rotor assembly, the rotor arm carrying a sensor magnet located at a radial distance from the rotational axis such that the sensor magnet circumscribes a circular path about the rotational axis when the magnetic rotor rotates, and wherein the first end of the rotor assembly is externally accessible at an opening in the housing such that the rotor can be rotationally driven by an external drive component; and
an ignition circuit comprising circuit components that include a plurality of magnetic field sensors and at least one power coil inductively coupled to the permanent magnet assembly of the magnetic rotor, the ignition circuit including high voltage output terminals mounted at an externally accessible location of the housing;
wherein the rotor assembly is a terminal mechanical device such that the rotor rotates within the housing without transferring its mechanical motion to any of the circuit components; and
wherein the plurality of magnetic field sensors are positioned adjacent the rotor arm at separate locations corresponding to the radial distance of the sensor magnet from the rotational axis of the rotor whereby, during rotation of the rotor arm by the rotor, the magnet sequentially passes by each of the magnetic field sensors.

Further aspects of the invention are described in the specification and claims below.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 shows in perspective a portion of a four cylinder aircraft piston engine with a left magneto constructed in accordance with a first embodiment of the invention and shown in partially exploded view;

FIG. 2 is an exploded view of a rotor assembly used in the left magneto of FIG. 1;

FIG. 3 is a perspective view of the left magneto housing of FIG. 1;

FIG. 4 is a perspective partial view of the first embodiment left magneto housing and a portion of the rotor assembly that connects to the piston engine;

FIG. 5A diagrammatically depicts one embodiment of the rotor assembly, position sensor, and power coils used to implement a fully electronic magneto;

FIG. 5B diagrammatically depicts another embodiment of the rotor assembly, position sensor, and power coils used to implement a fully electronic magneto;

FIG. 6 is a block diagram of the ignition circuit of a fully electronic magneto constructed according to the first embodiment of the invention as it would be electronically connected to four spark plugs of the four cylinder aircraft piston engine;

FIG. 7 is a schematic of a tank capacitor circuit of the ignition circuit of FIG. 6;

FIG. 8 is an electrical schematic of a power circuit of the ignition circuit of FIG. 6;

FIGS. 8A-8D show portions of the power circuit of FIG. 8 that each comprise a functional subcircuit, with FIG. 8A depicting a low speed startup circuit, FIG. 8B a normal mode circuit, FIG. 8C is a shutdown circuit, and FIG. 8D is an overvoltage protection circuit;

FIGS. 9 and 10 are electrical schematics that together depict the control circuit of FIG. 6;

FIG. 11 is a graph showing quadrature sinusoidal outputs of the position sensor during magneto operation and depicting various regions and setpoints used to implement ignition timing by the fully electronic magneto;

FIG. 12 shows in perspective a portion of a four cylinder aircraft piston engine with a left magneto constructed in accordance with a second embodiment of the invention and shown in partially exploded view;

FIG. 13 is an exploded view of a rotor assembly used in the left magneto of FIG. 12;

FIG. 14 is a perspective view of the left magneto housing of FIG. 12;

FIG. 15 is a perspective partial view of the second embodiment left magneto housing and a portion of the rotor assembly that connects to the piston engine;

FIG. 16 is a perspective view of the left magneto housing with its upper cap removed showing a sensor magnet attached to a rotor arm at the terminal, second end of the rotor assembly;

FIG. 17 is a perspective partial view showing the terminal end of the rotor assembly and a sensor board positioned adjacent to the rotor arm and containing position sensors used in connection with the sensor magnet to determine rotor angular position and rotational direction;

FIG. 18 is a top view of the left magneto housing with its upper cap removed showing the positioning of the sensor board, shown in phantom, relative to the rotor arm and its sensor magnet, as well as the relative positions of the position sensors on the sensor board;

FIG. 19 diagrammatically depicts the rotor assembly and power coils used to implement a fully electronic magneto of the second embodiment;

FIG. 20 is a diagrammatic representation of the power circuit's switching into and out of circuit the power coils to regulate the supply voltages;

FIG. 21 is a block diagram of the ignition circuit of a fully electronic magneto constructed according to the second embodiment of the invention as it would be electronically connected to four spark plugs of the four cylinder aircraft piston engine;

FIG. 22 is a schematic of a coil switching circuit used in the ignition circuit of the second embodiment;

FIG. 23 is a schematic of a self-oscillating flyback circuit used in the ingition circuit of the second embodiment;

FIG. 24 is a schematic of a control circuit used in the ignition circuit of the second embodiment;

FIG. 25 is a schematic of a discharge circuit used in the ignition circuit of the second embodiment;

FIGS. 26-28 depict prior art mechanical magnetos that use contact breakers and rotary switch distributors to power spark plugs of a piston aircraft engine.

### DETAILED DESCRIPTION

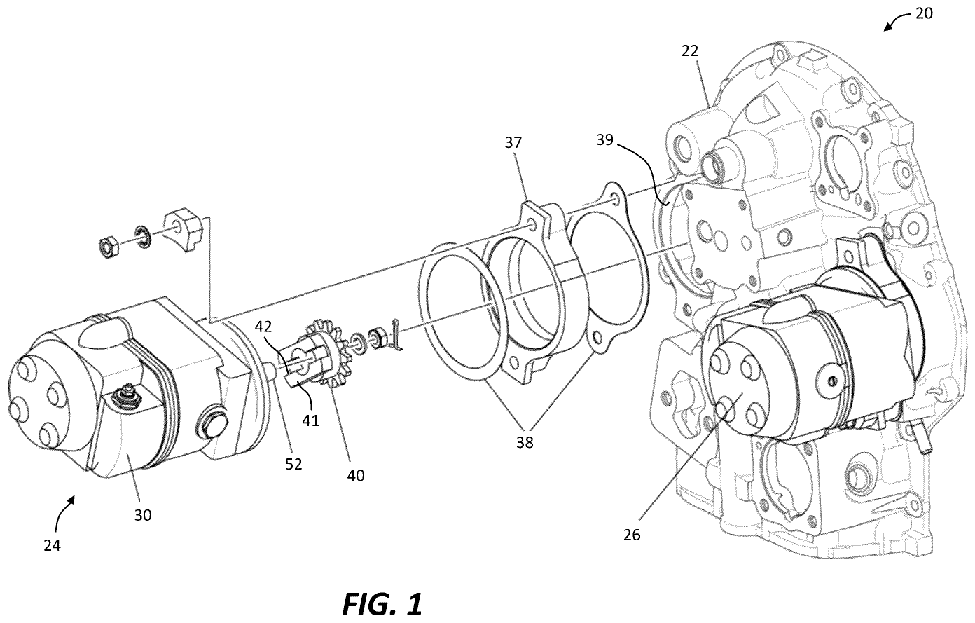

In FIG. 1 there is shown a portion of a four cylinder aircraft piston engine 20, including the auxiliary housing 22 of the engine to which are affixed a pair of left and right fully electronic magnetos 24, 26 constructed in accordance with a first embodiment of the invention. The two magnetos can be identical and are provided for redundancy, with the left magneto 24 driving upper spark plugs in each of the four cylinders and the right magneto 26 driving lower spark plugs in each of those same cylinders. In this way, all cylinders can be operated on either one or both of the two magnetos. The construction and operation of the left magneto 24 will be described below, it being understood that the construction and operation of the right magneto 26 can be identical.

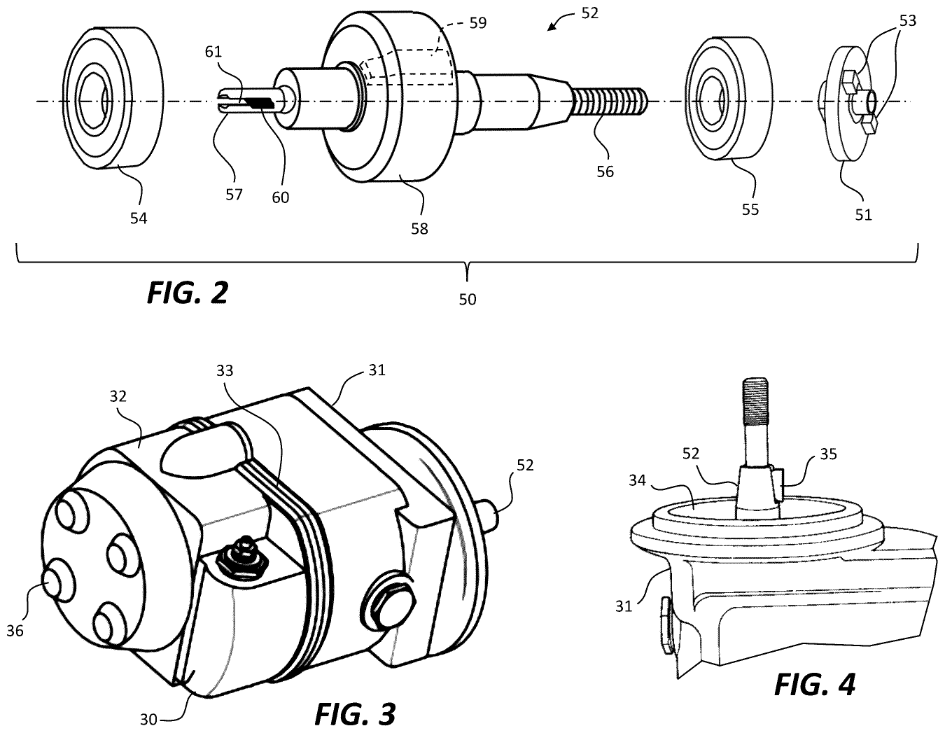

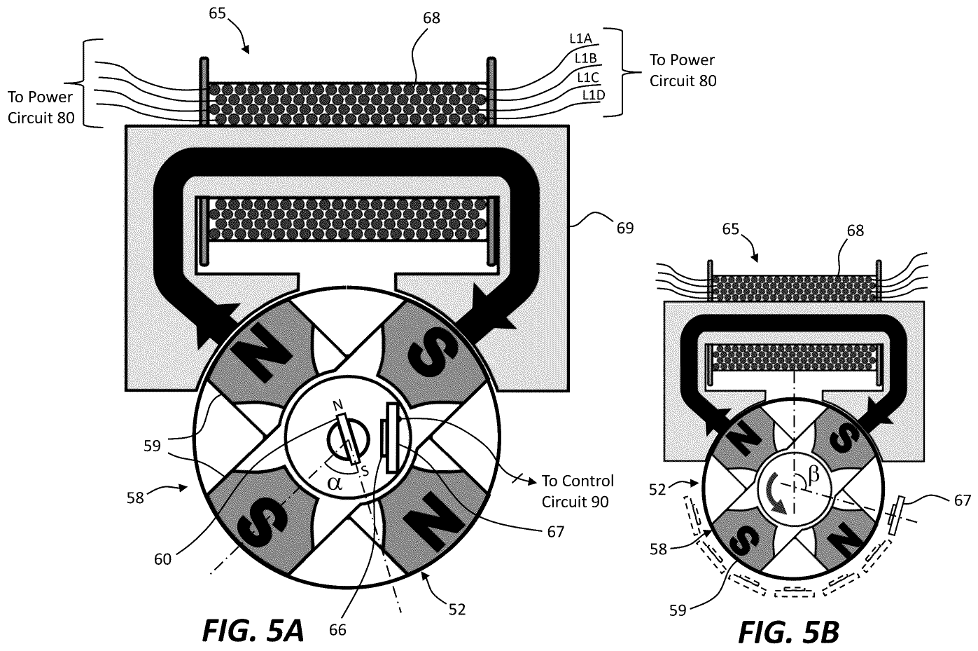

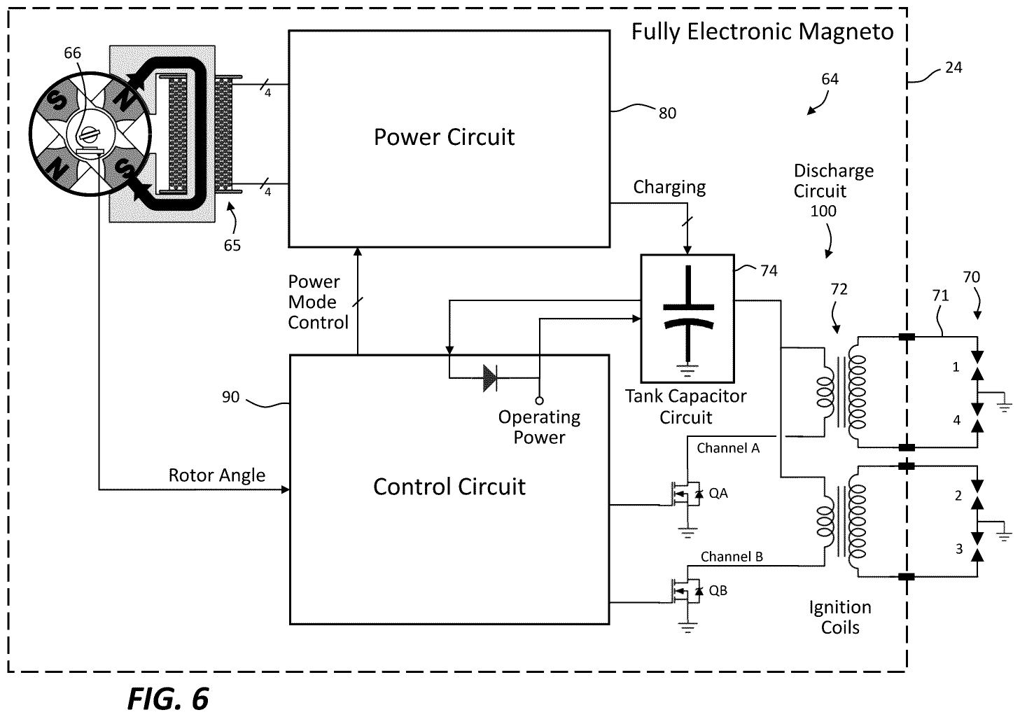

In general, the magneto 24 shown and described below comprises three main components or subassemblies: a housing 30, a magnetic rotor assembly 50 (FIG. 2), and an ignition circuit 64 (FIG. 6). Unlike mechanical magnetos, the rotor 52 of the rotor assembly 50 is not used to actuate additional mechanical components in the internal ignition circuit. Instead, an angular position sensor 66 (FIGS. 5A, 5B, 6, and 9) is used in combination with the rotating rotor 52 to determine rotor angle and electronically develop the desired ignition timing to properly fire the engine spark plugs. As will be described below, this fully electronic magneto construction is made possible using a reconfigurable charging coil arrangement comprising multiple coils that are inductively powered off the magnetic rotor 52 and that are electronically reconfigurable from a higher turn, lower amperage power coil when running at low speeds into a lower turn, higher amperage power coil when running at higher speeds. This allows the magneto 24 to develop sufficient spark voltages even at low speeds without any external electrical power connection and without any impulse coupling or other mechanical approach to generating ignition energy. In the following description, the magneto housing 30, rotor assembly 50, power extraction, and rotor position sensing will be described, followed by the ignition circuit 64.

The magneto housing 30 holds and provides a sealed enclosure for the rotor assembly 50 and ignition circuit 64. As indicated in FIGS. 3 and 4, the housing 30 can be a two-piece housing having a lower frame 31 and an upper cap 32 that can be fastened to the frame 31 along a parting line 33. Removable fasteners such as screws or bolts or permanent fasteners such as rivets can be used for this purpose. The housing 30 has an opening 34 in its lower frame 31 through which the rotor 52 can be connected to the engine 20, with a Woodruff key 35, flat, or other means used to lock rotation of the rotor 52 to whatever drive component is used to mechanically power it. The housing 30 further includes four high voltage output terminals 36 mounted at an externally accessible location of the upper cap 32 to which ignition leads can be connected to deliver ignition impulses from the magneto 24 to the spark plugs (shown schematically in FIG. 6). The ignition leads and spark plugs can be conventional or otherwise.

Referring back to FIG. 1, the components of the mounting interface for the left magneto 24 to the engine 20 are shown in exploded view and include an adapter 37 and gaskets 38 to seal the opening 34 in the magneto housing to a corresponding opening 39 in engine auxiliary housing 22. This interface also includes an external drive component 40 in the form of an external gear having an integral hub 41 slotted on its front axial face with a drive slot 42 for transfer of rotational motion to an input coupling 51 (FIG. 2) of the rotor assembly. Although the external drive gear 40 fits over the input end of the rotor 52, it is external in that it is not part of the magneto, but is actually located within the engine auxiliary housing 22 in use. The drive gear 40 meshes with an upstream gear in the engine that is driven directly or indirectly off the crankshaft using a gear ratio that results in the external drive gear rotating at the same rate as the crankshaft. Thus, the rotational angle of the external drive gear matches that of the crankshaft position. FIG. 2 shows the mechanical input coupling 51 that can be rigidly affixed to the rotor 52 for rotation therewith. The input coupling includes drive lobes 53 keyed to mate with the drive slot 42 of the external drive gear 40 so as to provide positive driving engagement of the input coupling 51. In this way, the rotor 52 is driven directly by the external drive gear 40 such that rotation of the rotor is locked to that of the engine crankshaft.

This drive lobe/slot coupling for transmitting drive power to the rotor 52 is typical of mechanical magnetos in that it enables use of an impulse coupling for which the rotor is not locked to the external drive component, but is driven via a lobed coupling shell, and yet allows for non-impulse coupling magnetos to utilize the same slotted external drive component using a simple lobed input coupling that is locked to the rotor, such as shown in FIG. 2. However, for the fully electronic magneto 24 described herein, other simpler drive connections can be used, such as by securing the external drive gear 40 onto the rotor 52 in a locked manner that does not permit relative rotation between them. This provides a more direct drive of the magneto rotor using fewer parts.

The rotor 52 comprises a portion of the rotor assembly 50 that also includes at least one bearing, but typically both an inner bearing 54 and an outer bearing 55 as shown. These bearings 54, 55 are used for rotationally mounting the rotor 52 in the magneto housing 30. The rotor 52 includes the lobed mechanical input coupling 51 (shown in reverse perspective from the other components of FIG. 2). The rotor 52 extends from a first end 56 to a second end 57 and includes a permanent magnet assembly 58 at a location between the first and second ends 56, 57. The permanent magnet assembly 58 can be a conventional or unconventional arrangement of one or more magnets 59 that present one or more pairs of strong magnetic poles facing radially outwardly. These magnets 59 are referred to herein as power magnets since they are used in combination with the charging coil of the ignition circuit 64 to generate the electrical power needed to run and fire the spark plugs. The rotor 52 further includes a sensor magnet 60 that is mounted within a radial slot 61 located in the second end of the rotor 52. The angular position sensor 66 itself is mounted to the housing 30 at a location adjacent to and facing this magnet 60, as shown and described in connection with FIGS. 5A and 5B.

The rotor assembly 50 contains no impulse coupling, retard breaker, camshaft, cam, or distributor drive gear. Consequently, it is much simpler in design and construction than that used in mechanical magnetos. And, given that the rotor assembly does not drive motion of any further component in the magneto 24, it constitutes a “terminal mechanical device” which, as used herein, means a device that undergoes movement when mechanically driven without transferring any of the motion to another device. In other words, the rotor 52 rotates free of any mechanical loading, it being understood by those skilled in the art that the bearings 54, 55 holding the rotor 52 are not considered a mechanical load. The rotor assembly 50 is the last in the chain of mechanically driven components, which in this case also include, in driven order, the crankshaft, the internal engine gear(s) to the external drive component in the auxiliary housing 22, and the mechanical input coupling 51 of the rotor assembly 50.

The elimination of an impulse coupling, retard breaker, camshaft, cam, contact breaker, and distributor is achieved by an innovative ignition circuit design that (i) is operated solely on electrical power produced internally within the magneto 24, (ii) includes an electronically reconfigurable charging coil 65 (FIG. 5A et seq.) that generates sufficient magneto power both at low (starting) engine speeds and at full engine speed, and (iii) is “fully electronic”, meaning that the ignition circuit 64 utilizes only non-mechanically actuated electrical components within the magneto 24 to generate and distribute the ignition pulses. This fully electronic ignition circuit 64 with its reconfigurable charging coil 65 allows for an ignition circuit in which, once the engine is started from a start motor, or even a proper manual turn of the propeller, ignition by the magneto 24 can begin even at engine speeds of about 100 rpm or less, and can continue throughout the entire range of engine speeds. And this fully electronic magneto 24 takes advantage of the fact that the mechanically-actuated circuit components in mechanical magnetos are all linked functionally to the need for control of the timing and distribution of the ignition pulses. In the illustrated embodiment, that ignition timing functionality is achieved electronically using a single angular position sensor 66 (FIGS. 5A, 5B, 6, and 9) located adjacent the sensor magnet 60 of the rotor 52 to detect the instantaneous angular position of the rotor, and thus the engine crankshaft. As will be described below, the distribution of the ignition pulses to the cylinders is achieved electronically using a plurality of ignition channels, each with its own ignition coil.

In general, the position sensor 66 may be any suitable angle sensor that outputs rotational angle data with sufficient accuracy and resolution for use by the ignition circuit 64 to provide speed detection and proper ignition timing, whether fixed, continuously variable, or variable among two or more speed ranges. For this, the sensor 66 should be one that resolves the rotor angular position with sufficient accuracy and resolution for use by the ignition circuit 64 in properly timing the ignition pulses. In the illustrated embodiment, position sensor 66 is a magneto-resistive sensor that provides quadrature sinusoidal signals which are used by the ignition circuit 64 to resolve the angular position of the rotor 52 and, thus, the engine piston position relative to its TDC. An example magneto-resistive sensor that may be used is the commercially-available TLE5501 TMR-based angle sensor. Optical and other non-magnetic angle sensors may be used some embodiments depending on the particular magneto application.

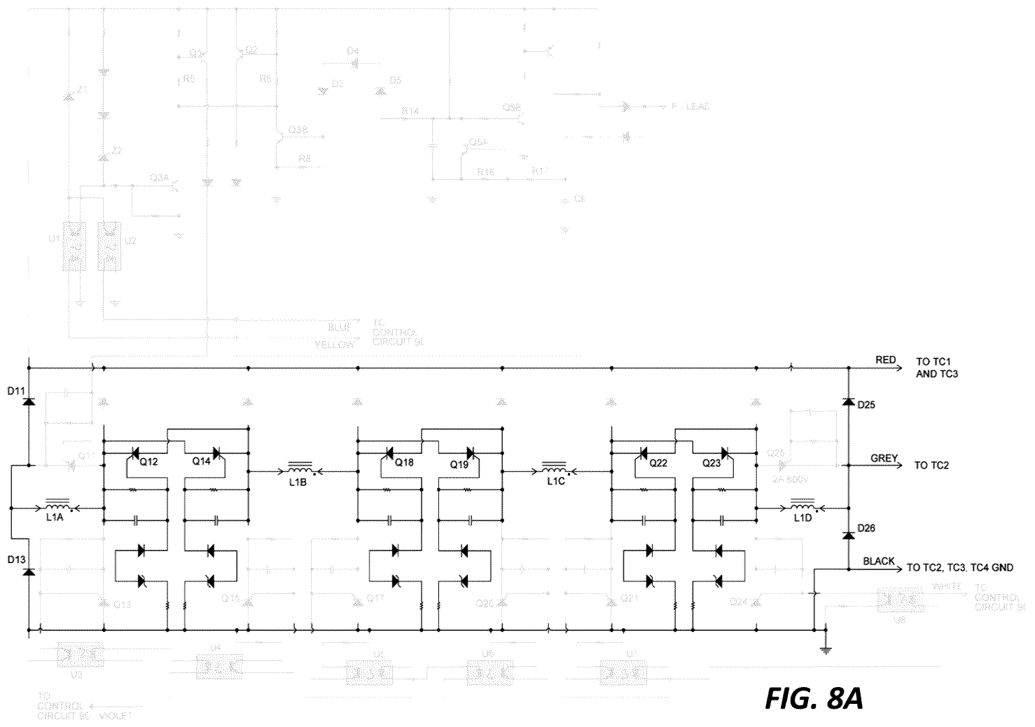

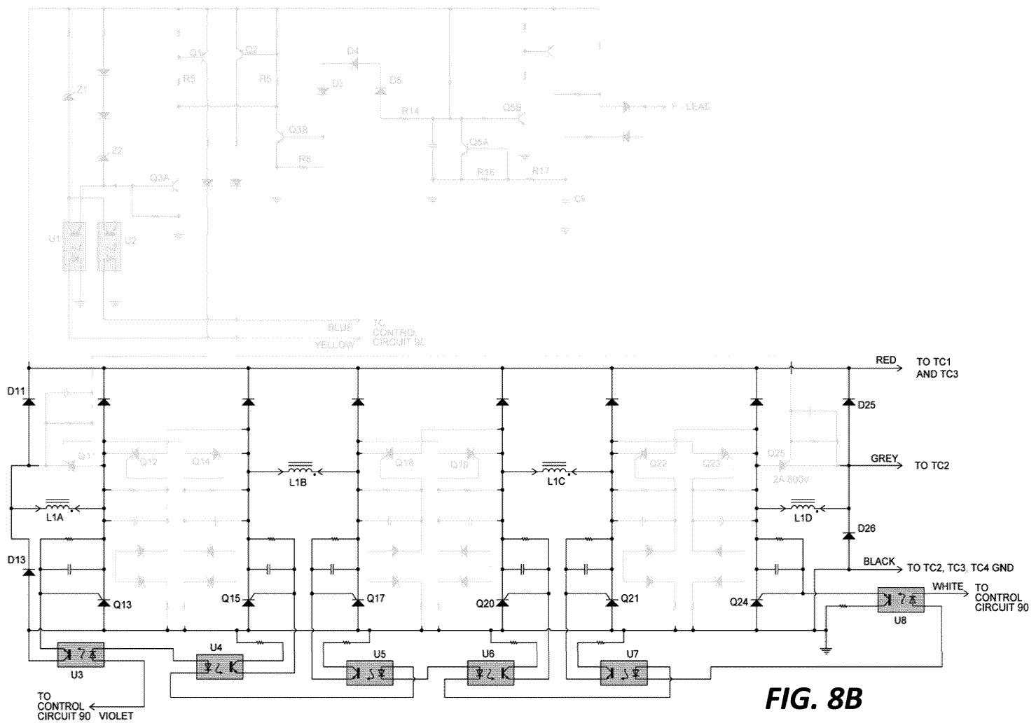

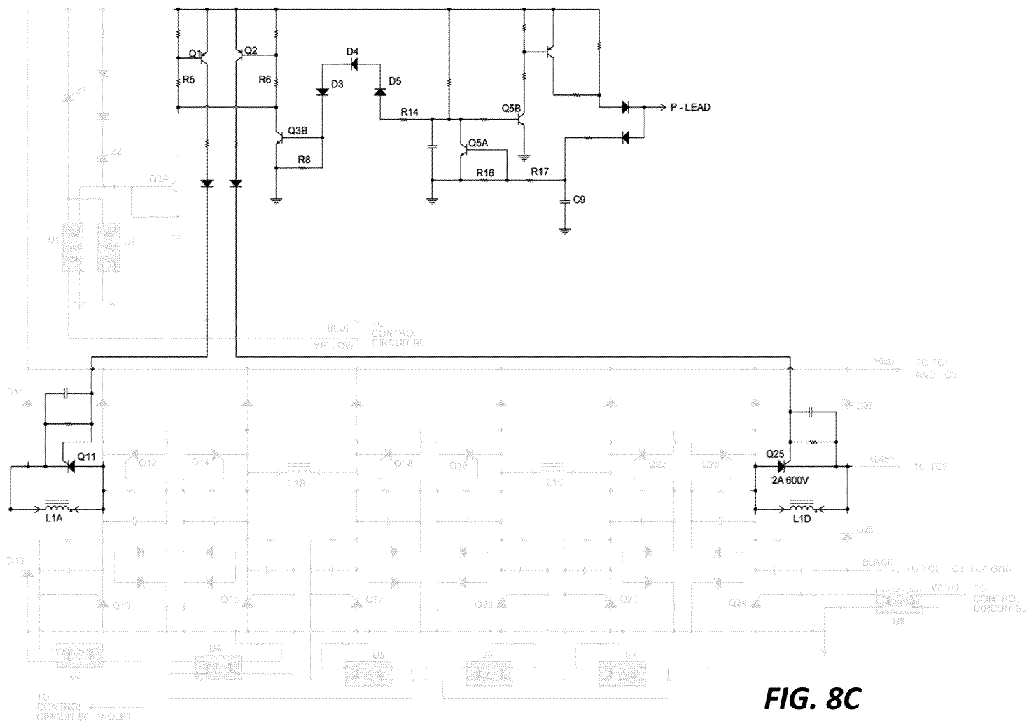

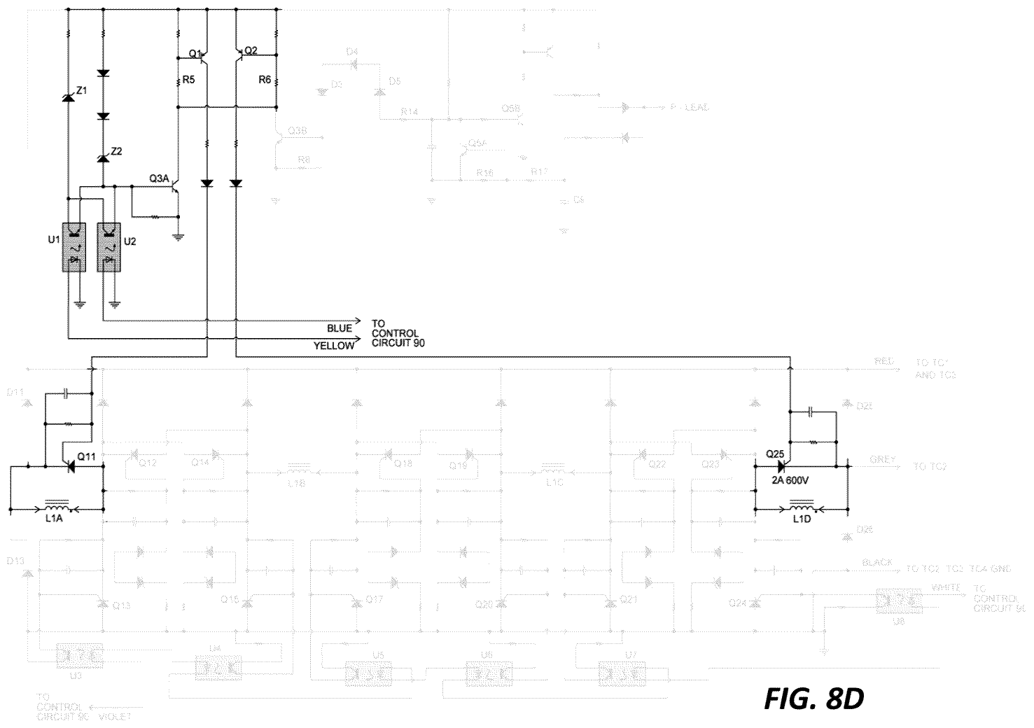

FIG. 5A shows diagrammatically the design of the reconfigurable charging coil 65 used to extract power from the rotating magnetic fields generated by the rotor 52, as well as the incorporation of the position sensor 66 into the housing 30 adjacent the rotor. The charging coil 65 comprises four separate power coils 68 (individually labeled L1A, L1B, L1C, L1D in the circuit diagrams of FIGS. 8-8D), with the power coils 68 each constructed of the same wire and number of turns which are wound on a ferromagnetic core 69 positioned in the housing 30 adjacent the power magnets 59 of the rotor 52 to concentrate and guide the changing magnetic field lines that extend between opposite magnetic poles of the rotor 52 as the rotor spins. The instantaneous rotor position in FIG. 5A shows the rotor angle at which maximum flux occurs in the core 69. The magnetic field lines are shown in the aggregate with the direction of those fields lines from North to South indicated by the arrows. As the rotor continues to turn, the magnetic field will collapse to zero and then reverse direction and increase again to maximum flux as the rotor reaches 90° from the position shown. These rising and collapsing magnetic fields induce current flow through each of the four power coils 68, allowing them to be used in the ignition circuit 64 as four separate electrical sources that are summed together to generate a sufficient dc voltage and amperage to fire the engine spark plugs via the ignition coil.

Further, the four power coils 68 can be electronically configured by the ignition circuit 64 into series or parallel connections of the coils. This enables self-powering of the magneto 24 across the full range of engine speeds, from startup to maximum rpm. All without the need for an external power supply connection and without the use of extra mechanical components.

The position sensor can be printed circuit board (PCB) mounted, with the sensor 66 and PCB together referred to as a sensor board 67, as is shown in FIG. 5A. This sensor board 67 is mounted to the housing 30 adjacent the sensor magnet 60 of the rotor 52, which is axially-spaced from the power magnets 59 so as to avoid interfering magnetic fields. In FIG. 5A, an end view of the rotor 52 is shown with the magnet 60 affixed in the slot 61 at the second end 57 of the rotor. The sensor board 67 is also shown to indicate its positioning relative to the sensor magnet 60 and, although not shown in this figure, is secured to the magneto housing 30 at this location and orientation. As opposed to the four pole power magnets 59, the sensor magnet 60 includes a single N-S pole pair such that the sensor 66 generates one complete pair of quadrature sinusoidal waveforms per revolution of the rotor 52.

The fixed rotational orientation of the sensor magnet 60 on the rotor is shown at an angle α relative to that of the power magnets 59. In particular, this angle α is an angle measured between the centerline of the N-S poles of the sensor magnet 60 and a particular pole of the power magnets 59. The angle α shown is arbitrary, but in use this angle will advantageously be predetermined such that when the magneto is synchronized to piston TDC. For example, the North pole of the sensor magnet can be oriented directly adjacent the position sensor (e.g., at the 3 o'clock position shown in FIG. 5A), whereby the power magnets' poles will be in a desirable alignment relative to the ferromagnetic core and coils. This desirable alignment can be, for example, a position providing maximum or minimum flux in the core 69 or something therebetween that provides advantageous or optimal timing of the coil energization relative to the ignition pulse timing. Such alignment can be determined in the design stage and/or through testing.

FIG. 5B depicts an alternative sensor arrangement wherein the sensor board 67 is located adjacent the permanent magnet assembly 58 of the rotor 52 at an angular (or circumferential) location that is offset from the location of the power coils 68 and ferromagnetic core 69. This offset location forms an angle B from the angular location of the coils 68 and core 69. This angle is shown as being sufficiently large so as to avoid interference by the coils and core with the magnetic field sensed by the sensor 66. It can be selected in the range of 90-180° on either the right or left side of the vertical centerline shown in FIG. 5B, and angles less than 90° may be used depending on the circumferential extent of the coil/core package. In this embodiment, the rotor 52 need not have any separate sensor magnet 60, because the same magnet(s) 59 used to energize the power coils 68 are also used for rotor position sensing. However, this reduction in parts count advantage may be offset by more difficulty in obtaining proper accuracy and resolution of position and, consequentially, more complex processing circuitry.

For this embodiment, it is also advantageous to both synchronize the position sensor output signals with piston TDC and provide a desirable angular alignment of the power magnets 59 with the power coils 68. This can be done by determining and fixing the sensor board 67 position in the housing 30 relative to the angular position of the rotor poles so that the desired alignment with the coils 68 is achieved. Such a location may be at any of the discrete optional locations shown in FIG. 5B or in between such positions, as determined by design and/or testing.

Turning now to FIGS. 6-10, the ignition circuit 64 will now be described. FIG. 6 is a functional block diagram view of the ignition circuit 64 of the fully electronic magneto 24 and is shown connected to four spark plugs 70 by ignition leads 71. The ignition circuit 64 includes the position sensor 66 and the reconfigurable charging coil 65 from which the ignition circuit 64 obtains only magnetic field inputs, and only from the rotating magnetic rotor 52. One magnetic input is the reversing magnetic field from the power magnets 59 and the other magnetic input is from the position sensor magnet 60. The ignition circuit 64 is logically and (mostly) physically separated into three main circuits-a power circuit 80, a control circuit 90, and a discharge circuit 100. The power and control circuits 80, 90 are implemented on separate printed circuit boards (PCBs) mounted in the housing 30, and the discharge circuit 100 is mostly separately packaged components, also mounted in the housing. The circuit boards and discrete discharge circuit components are interconnected by soldered wiring running between them.

In general, power is extracted by the charging coil 65 that is made up of the four power coils 68 (L1A-L1D). This extracted power is induced in the power coils 68 from the changing magnetic field lines produced by the rotor 52 during rotation. These coils 68 form a part of the power circuit 80, but are located adjacent the rotor 52 for inductive coupling. The power circuit 80 uses the induced current from the coils 68 to charge tank (or storage) capacitors in a tank capacitor circuit 74. This stored charge from the tank capacitor circuit 74 provides the electrical power needed to operate the control circuit as well as providing the energy needed by the discharge circuit to fire the spark plugs 70. For a four stroke, four cylinder engine with two pairs of identically timed pistons (i.e., having the same TDC) that are reciprocating together at 180° or other angle relative to the other pair, the ignition circuit 64 can be configured as shown to run in a wasted spark configuration, with cylinders 1 and 4 firing together (as well as cylinders 2 and 3 firing together) even though one of each pair of cylinders is near TDC between exhaust and intake strokes, rather than between the compression and power strokes. This allows the ignition system to run with only two channels A and B using only two ignition coils 72 that have the different ends of their secondary connected to a different spark plug 70 in a different one of the two cylinders in the pair.

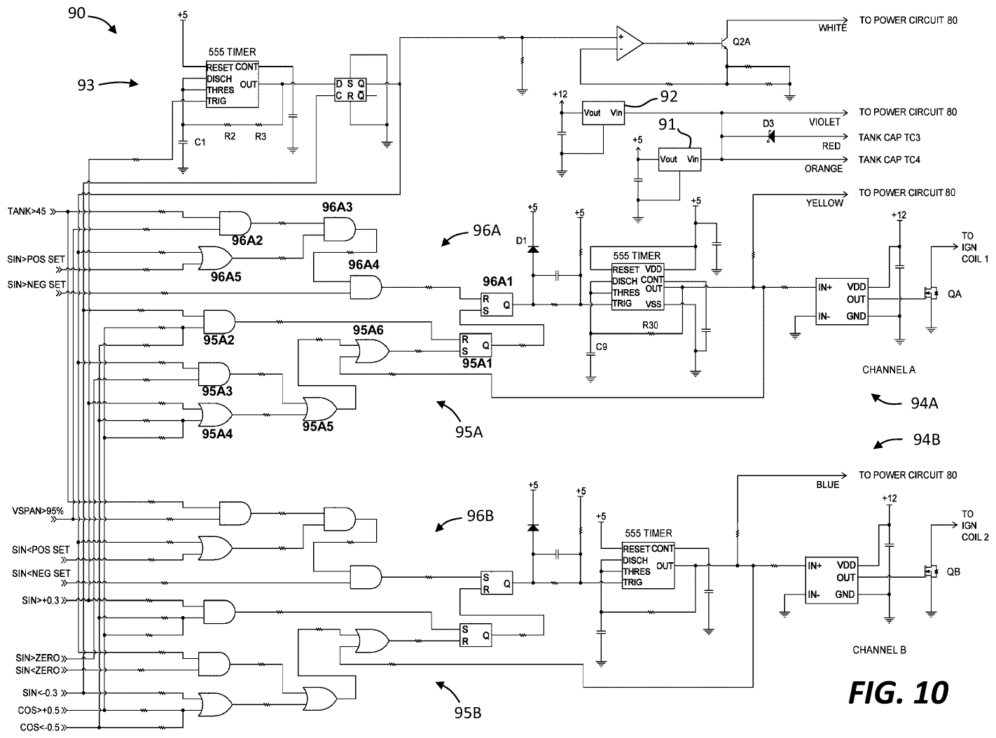

Although various spark generation circuits may be used, the illustrated embodiment uses a capacitive discharge ignition (CDI) scheme wherein the charge stored in the tank capacitor circuit 74 is drawn through the primary of the ignition coils 72 by power transistors QA and QB (FIG. 10) and then suddenly interrupted by switching off the transistors, thereby causing a large voltage across the secondary of each ignition coil, as is known. This is discussed farther below in connection with the construction and operation of the discharge circuit 100.

Sufficient electrical power for the ignition circuit 64 and sparking of the plugs can be achieved at both startup and normal speeds without a separate electrical source by using the plurality of power coils 68 wrapped on the core 69, whether side-by-side or overlapping, with the coil outputs being summed together to develop sufficient voltage and current for charging the tank capacitor circuit 74 to the voltage needed to ignite the spark plugs 70 via the ignition coils 72. In the illustrated embodiment, four power coils 68 are used to generate this charging current using a reconfigurable charging coil approach that sums or superimposes the coils' voltages at low speeds and sums the coils' currents together at higher speeds. Although four coils are used in the embodiment shown, other embodiments may use more or less power coils as desired or needed for a particular application.

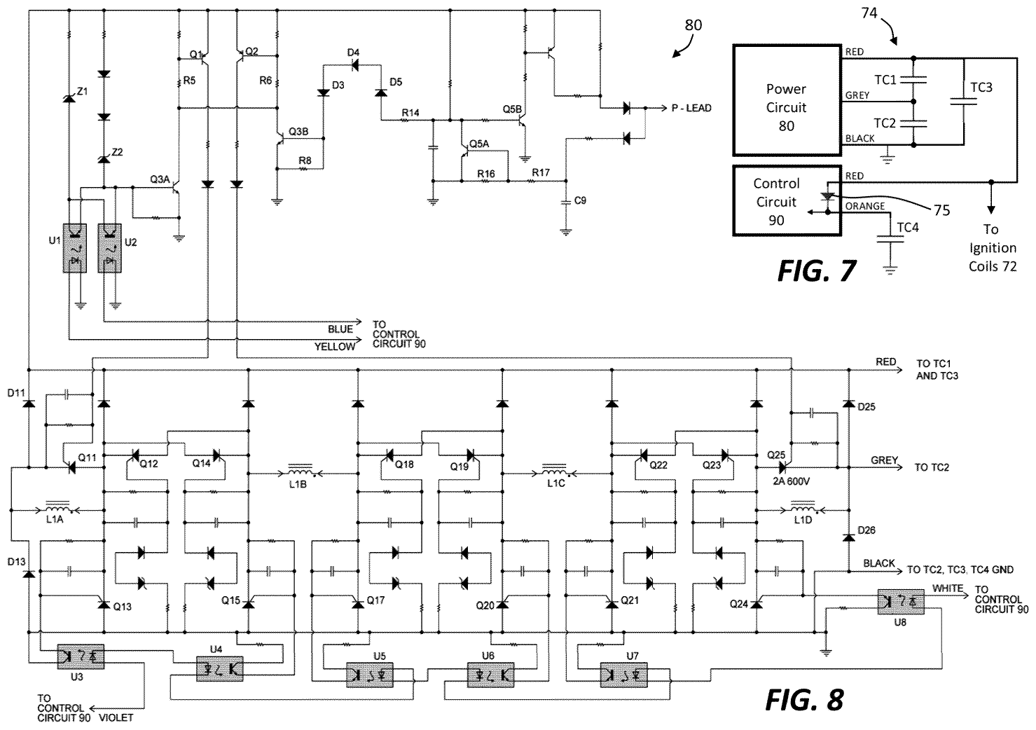

As shown in FIG. 7, there are four capacitors used that together constitute a tank capacitor circuit 74 hardwired together. Each capacitor TC1 through TC4 can be an identical capacitor, such as 47uF, although different capacities may be used. As will become apparent by inspection of the power circuit of FIG. 8, the capacitors TC1 and TC2 are wired in combination with the diode-steered summed voltages from the power coils 68 to act as a voltage doubler to assist in charging tank capacitor TC3 to a sufficient dc voltage. Also, as indicated in FIG. 6, the tank capacitor circuit 74, in particular tank capacitor TC3, provides operating power to the control circuit 90. To decouple the discharging of TC3 during ignition events from the control circuit operation, this power feed from TC3 is used to charge the fourth capacitor TC4 via a diode 75 mounted on the control circuit board that prevents reverse draw of power from TC4. Thus, both TC3 and TC4 operate as storage or tank capacitors, to provide electrical power to operate the ignition coils and to operate the control circuit, respectively.

FIG. 8 depicts the power circuit 80. It is a mostly analog circuit that includes the four power coils 68 and four intertwined subcircuits: a low speed (startup) circuit 82, normal mode circuit 84, shutdown circuit 86, and overvoltage protection circuit 88. The shutdown circuit 86 is connected to the standard pilot's P-Lead which, when shorted prevents magneto operation, and when opened permits magneto energization and, hence, engine operation. Upon opening the P-Lead connection, an engine starter motor or other means can be used to rotate the engine and begin generation of magneto operating power and cylinder ignition. For this, the ignition circuit 64 begins in the startup mode, using the low speed circuit 82 that is configured to generate sufficient magneto operating power and spark energy to fire the spark plugs 70, even at engine rotational speeds as low as 100 rpm or possibly less, depending on the particulars of the circuit design and component selection. Once the engine begins running on its own, it speeds up to above a threshold engine speed, typically around 600 rpm. Thereafter, the power circuit 80 switches to its normal operating mode using the normal mode circuit 84 to generate appropriate charging voltage and current for the tank capacitor TC3.

Engine shutdown can be manually controlled by the P-Lead via a pilot ignition switch (not shown) that grounds the P-Lead. This switches the power circuit 80 to the shutdown mode by activating the shutdown circuit 86 which shorts out one or more of the power coils 68, thereby preventing any of the four inductively-linked power coils 68 from supplying operating power. In the absence of any ignition sparks, the engine winds down to a stop.

The overvoltage protection circuit 88 leverages some of same circuitry used for shutdown to shunt the one or more power coils 68 intermittently (i.e., each charging cycle as needed) when the voltage at the tank capacitor TC3 has reached its maximum desired charging voltage, as well as following an ignition impulse to ensure that the voltage rise on TC3 is not too fast.

All of the power circuit components can be integrated together onto a PCB, with the exception of the power coils 68 (i.e., L1A, L1B, L1C, L1D) which are wrapped around the ferromagnetic core 69 adjacent the magnetic rotor 52. The eight leads from those coils 68 can be soldered to the PCB at their designated electrical pads. As will be appreciated, the power input to the power circuit 80 is solely magnetic field lines from the rotating rotor's power magnets 59. Power coils L1A-L1D are all wound with the same polarity on the core 69, as indicated. Higher voltage, lower current power coils, such as can be formed by 1000 or more turns of wire per coil, are able to jointly supply sufficient electrical power—either by being voltage summed in series together for low speed operation, or by being current summed in parallel together for higher speed (normal) engine operation. In this way a single charging coil package can be fit within a standard magneto housing and electronically reconfigured into different coil configurations for the different power and ignition needs. And this charging coil reconfiguration permits the magneto 24 to develop sufficient voltage at the tank capacitor TC3 to fire typical aircraft piston engine spark plugs 70 once per crankshaft revolution at speeds as low as 100 rpm or less, without any mechanical impulse coupling or external power supply.

The power circuit 80 has five control inputs, the first of which is the pilot ignition switch P-Lead that is part of the shutdown circuit 86 and which, if grounded, shuts off engine ignition power. It is meant to be in an open (high impedance) state to permit ignition circuit operation. The other four control inputs to the power circuit 80 come from the control circuit 90. Two of these, identified by the violet and white labeled offboard wire connections, are to control the power circuit mode between the startup and normal operation modes. The other two, identified as yellow and blue labelled wire connections, shuts down the power coil charging of the tank capacitors during ignition impulses, as will be explained.

The power circuit 80 has three power outputs that lead to the tank capacitor circuit 74 (see FIG. 7) which is part of the discharge circuit 100 and includes the four discrete capacitors TC1-TC4. Since these capacitors are potted and off-board, they are connected by wiring using the color codings indicated. As will be understood by those skilled in the art, the D11/D13/D25/D26 diode-steered connections to capacitors TC1 and TC2 form a modified voltage multiplier for the power supplied by the four L1 power coils 68.

FIGS. 8A-8D depict different portions of the power circuit 80 of FIG. 8, with the four portions shown comprising the four different subcircuits 82, 84, 86, 88 of the power circuit 80. For each of the FIGS. 8A-8D, only the specific subcircuits are shown, with the remaining portions of the power circuit 80 grayed out to assist in the identification of the subcircuit components being described.

FIG. 8A depicts the low speed startup circuit 82 used to generate magneto and spark power at very low engine rpms. This circuit 82 is activated by the control circuit 90 using a transistor switch Q2A (FIG. 10) that toggles the power circuit's operating mode between startup and normal, based on engine speed. A speed detector 93 (FIG. 10) operating off the position sensor 66 is used to determine this rotor/engine speed. For startup mode, the switch Q2A is put in an off (non-conducting) state, preventing current through the U3-U8 opto-isolators, leaving them off, and causing thyristors (SCRs) Q13, Q15, Q17, Q20, Q21, and Q24 to remain off as well. As a result, the forward bias voltage energizes the gates of thyristors Q12, Q14, Q18, Q19, Q22, and Q23 which electrically connects power coils L1A-L1D together in series and, with diodes D11, D13, D25, and D26, into a full wave rectifier that also forms a modified voltage multiplier in combination with capacitors TC1-TC3.

In this startup mode, the voltage stacking of the four power coils 68 electronically connected in series helps overcome the lower induced voltages that occur at slower rotational speeds of magnetic rotor 52. This startup circuit 82 thus provides advantages over retard breaker magnetos in that it does not require an external source of electrical power, nor does it need produce a shower of sparks at each engine startup. This circuit 82 also is advantageous relative to impulse coupling magnetos since it eliminates one of the mechanical wear and possible failure components of those mechanical magnetos.

Turning now to FIG. 8B, there is shown a normal mode circuit 84 that takes over operation of the power circuit 80 once as the engine is throttled beyond its low speed startup range. The control circuit 90 monitors the engine speed via the angular position sensor 66 by comparing it to a predetermined speed threshold of 600 rpm, although other predetermined speeds above or below 600 rpm may be used. Below this threshold, the control circuit 90 keeps the power circuit 80 in the low speed (startup) mode. Once the threshold is reached or exceeded, the control circuit 90 switches the power circuit 80 into the normal operating mode in which the circuitry of FIG. 8B becomes active. This is accomplished by energizing the opto-isolators U3-U8 which are connected to the gates of thyristors Q13, Q15, Q17, Q20, Q21, and Q24 allowing them to conduct. This electronically reconfigures the four power coils L1A-L1D into parallel-connected coils which has the effect of forming a lower turn, higher amperage coil by summing their currents together rather than their voltages. As in the startup mode, this aggregated electrical power is used to charge the tank capacitors TC3 and TC4 via the full voltage rectifier formed by diode D11, D13, D25, and D26.

Due to the higher speeds of rotation of the magnetic rotor 52 during normal engine operation, the concomitant higher rate of reversing magnetic field lines impinging upon the power coils 68 induce higher per-coil voltages than at lower speeds, thus allowing a single one of the power coils 68 to develop sufficient peak voltage to charge the tank capacitor TC3 to the proper voltage. And the remaining three power coils 68 connected in parallel with the first coil 68 multiple the amount of current supplied to charge TC3, allowing it to reach proper voltage much faster than when the charging coil 65 is in the voltage-summed configuration.

FIG. 8C depicts the shutdown subcircuit 86 that is activated from the P-Lead. Upon grounding the P-Lead via the pilot's ignition switch, capacitor C9 discharges through R16 and R17 until transistor Q5A turns off, allowing current conduction through diodes D3-D5 and resistor R14, forming a voltage divider with R8 that turns on transistor Q3B, grounding the common node between resistors R5 and R6, thereby allowing pnp transistors Q1 and Q2 to conduct. This feeds power to the gates of thyristors Q11 and Q25 permitting conduction through the thyristors that short out whichever of the power coils L1A and L1D currently has positive polarity in the forward conduction direction of its associate thyristor. Because all four power coils 68 are tightly inductively coupled, the voltage across all coils falls to near zero regardless of rotor rotation. Ignition then ends such that the engine powers down.

FIG. 8D depicts the fourth subcircuit portion of the power circuit 80; namely, the overvoltage protection circuit 88. This circuit 88 activates when needed, using the same thyristors Q11 and Q25 to at least momentarily stop the charging of the tank capacitors TC3, TC4 during certain conditions. The first condition is overvoltage at the tank capacitors. Zener diode Z2 sets the overvoltage setpoint and can be, for example, a 47v, ½ Watt Zener that when its breakdown voltage is exceeded, turns on transistor Q3A which is collector-connected to the same common R5/R6 node as Q3B and so operates the same to turn on Q1 and Q2 to thereby one-way shunt the power coils L1A and L1D. The second condition that triggers the overvoltage protection circuit is the ignition firing in each of the two discharge circuit 100 Channels A and B (FIGS. 6 and 10). The same pulse signal used to switch on and off the ignition coil power transistors QA and QB is used to activate opto-isolators U1 (Channel A) and U2 (Channel B). Thus, the opto-isolators will alternate operation, each switching on only for the duration of its channel's ignition pulse. When an opto-isolator is activated, current conducts through a suitable (e.g., 47v or less) zener diode Z1 and is supplied to the base of transistor Q3A to temporarily shunt the power coils 68 during ignition. This helps ensure that the voltage rate of rise on the tank capacitor TC3 is not too fast following the spark.

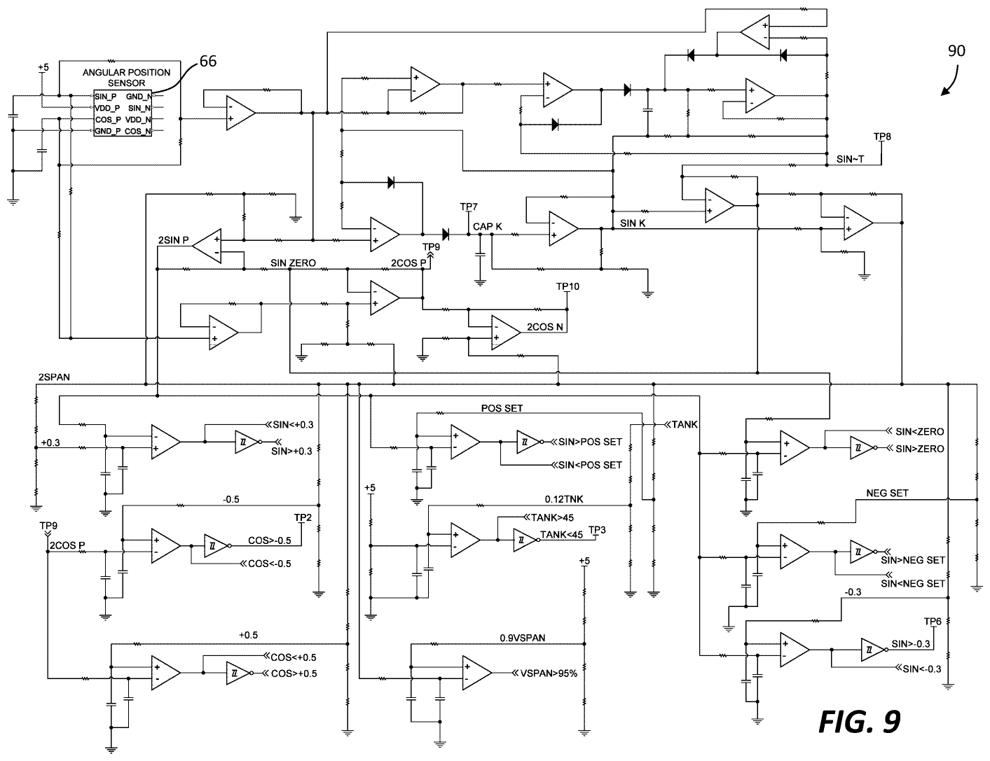

Turning now to FIGS. 9 and 10, the control circuit 90 is shown. As noted above and shown in FIG. 10, charging power provided to the tank capacitor TC3 is inputted on the red wire input and charges tank capacitor TC4 via diode D3 that prevents current draw from TC4 by the discharge circuit 100 when powering the ignition coils 72 for spark ignition. That TC4 operating power runs the control circuit 90 and is developed into two regulated voltages, a +5v and a +12v supply using suitable linear, switch mode, or other voltage regulators 91 and 92.

FIG. 9 depicts the angular position sensor 66, various generated voltage setpoints, op-amps, and comparators used with the setpoints to provide logic level binary values that are used by the discrete logic circuitry of FIG. 10 to determine the timing of ignition pulses for each of the two channels. The op-amps are located above the horizontal 2SPAN signal line shown in FIG. 9 and the comparators are located below that signal line. The setpoints are indicated by name and are generated off different fixed and variable voltages; in particular, from the +5v logic supply voltage, the tank capacitor TC3, and the sine and cosine waveforms supplied by the angular position sensor 66 when the rotor 52 rotates. To normalize the setpoints to the sensor peak output, a voltage of about twice the sensor peak amplitude (2SPAN) is generated and used to determine the voltage of various setpoints. Also, a minimum expected sensor peak amplitude is determined for which a separate binary state signal, VSPAN>95%, is generated and used to gate the ignition pulse firing in the timing logic. The position sensor setpoints represent particular points during a single cycle of the sensor outputs which is once per rotor (and engine) revolution. These points are used by the discrete logic circuity to determine crankshaft angle and, thus, proper ignition timing.

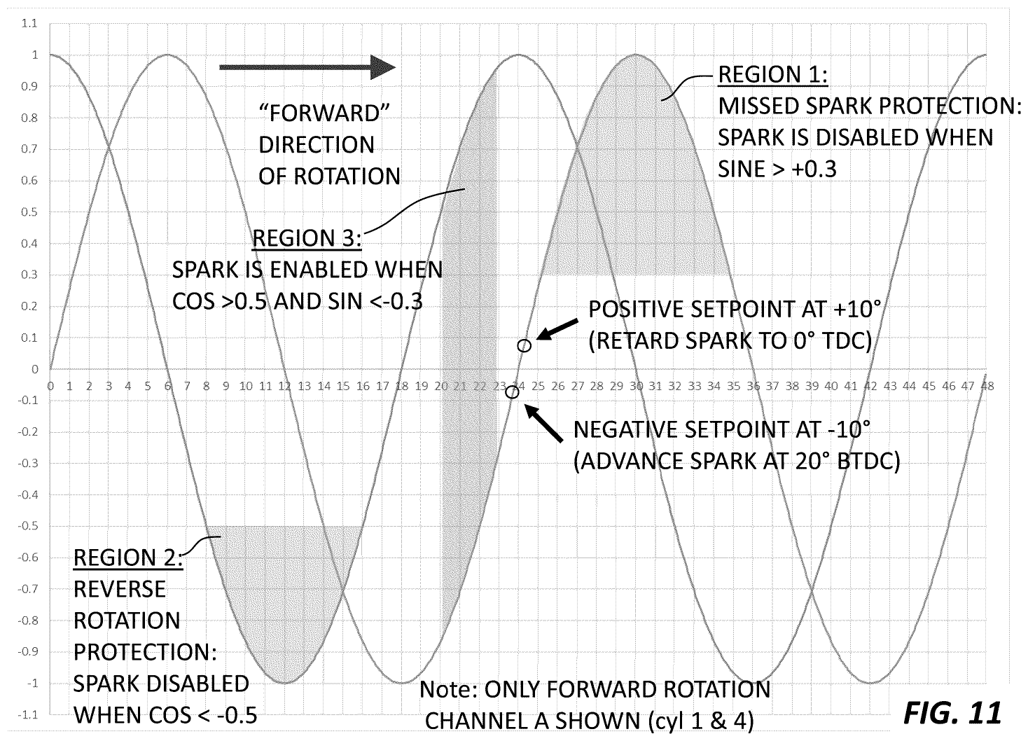

The selection and use of these position sensor setpoints can be best understood by reference to FIG. 11. It shows the quadrature sinusoidal outputs of the position sensor, both sine and cosine waveforms that are generated when the magnetic poles of the sensor magnet pass the sensor. For ignition timing that mimics that of a typical mechanical magneto, such as a Champion Aerospace® Slick® 4371™ magneto, it needs to have a first, fixed firing angle for speeds under 600 rpm, and a second, fixed firing angle for speeds above that predetermined threshold. The first, low speed firing angle is retarded from normal operation at 0° TDC, but can be in the range of about 0-10° after TDC. The second, normal operation firing angle is advanced to 20° before TDC, but can be in the range of about 18-28° before TDC. Also, the 600 rpm setpoint is merely an example speed threshold for ignition timing changes. Generally, any engine speed in the range of 250-600 rpm can be used. Regardless of the setpoints and thresholds selected, the discrete logic circuitry needs to identify the proper locations along the course of a period of these sinusoidal waveforms to spark at the different engine speed ranges.

In the sensor output of FIG. 11, each X-axis unit is 15° of rotation and the sine and cosine amplitudes are normalized to 1.0. The sine wave is used for timing, whereas the cosine waveform is used for a directional check. As indicated in FIG. 11, there are three primary regions of interest. The first, Region 1, is any point during rotation when the sine wave is >0.3 (or 30%) of the peak amplitude. This represents a region of angles for which the spark would come too late for the power stroke, and so the setpoint representing this region is used to disable ignition firing during these angles. The second is Region 2, which is anytime the cosine wave is <−0.5 (the lower 50%) of the peak amplitude. This is a region of angles during which the ignition could cause reverse engine rotation, and so this setpoint is also used to disable ignition firing in this region of angles. Region 3 are the angles leading up to the desired spark ignition timing and is used to enable the ignition circuit for timely spark generation. As noted in FIG. 11, this region occurs when the cosine wave is >0.5 and the sine wave is <−0.3.

Referring back to FIG. 9, it can be seen that these regions are identified by the various setpoints developed from the position sensor output, with comparators being used to represent the setpoints and their inverses as 0/5v binary voltages. Thus, 0v represents a LO or binary 0 value, and 5v represents a HI or binary 1 value.

FIG. 10 includes the remainder of the control circuit 90 and, in particular, includes control logic that, based on rotational angle data from the position sensor, controls timing of the ignition pulses relative to the magnetic rotor's rotational angle as a function of rotor speed. This control logic includes a speed detector (circuit) 93 that switches the power circuit 80 between low speed and normal speed modes to thereby cause a change in ignition timing of the ignition pulses depending on whether the rotor speed is above or below a predetermined speed. The control logic also includes two ignition Channels A and B having ignition coil firing circuits 94A, 94B each controlled by both respective firing enable circuits 95A, 95B and timing logic 96A, 96B. The construction and operation of only the upper ignition Channel A (circuits 94A, 95A, 96A) will be described, it being understood that Channel B can be identical.

The firing enable circuit 95A and timing logic 96A implement the conditions described above and shown in FIG. 11. The firing enable circuit 95A uses discrete logic circuitry to carry out the Regions 1-3 requirements based on the various state conditions identified by the signals on the left side of the figure that were produced by the setpoint and comparator circuitry of FIG. 9. Circuit 95A includes an SR latch 95A1. Because the commercially available SR latches are Set-priority, the logic convention used in the circuit is Set (HI) when the firing is to be disabled/blocked. The upper AND gate 95A2 represents the desired Region 3 for which ignition firing commencement is desired, and its output is connected to the Reset of SR latch 95A1. Note that Region 3 is not the angle range in which firing occurs, but is the region in which the firing circuit 94A is switched to an enabled state for subsequent firing. The remaining AND gate 95A3 and three OR gates 95A4, 95A5, 95A6 set the SR latch 95A1 to HI to disable firing when in Regions 1 or 2, thereby requiring the crankshaft angle to re-enter Region 3 each cycle before the firing circuit 94A is re-enabled.

The SR latch 95A1 is fed into another SR latch 96A1 in the timing logic, connected to its Set input so that, when ignition is enabled by the firing enable circuit 95A, the Set input of the timing logic SR latch 96A1 is at a logical 0 (LO) allowing its Q output to switch from HI to LO upon reset, which then triggers the ignition coil firing circuit 94A. Using the three AND gates 96A2, 96A3, 96A4 and OR gate 96A5, the timing logic 96A sets its SR latch 96A1 reset input if the following conditions are satisfied: 1) Tank Capacitor TC3>45 Volts AND 2) the position sensor peak detector (VSPAN) >95% of minimum expected voltage AND 3) the position sensor is at least at the −10° advance timing point (SIN>NEG_SET) AND either 4A) Speed >600 RPM OR 4B) the position sensor 66 is at or beyond the +10° retarded firing point (SIN>POS_SET). The binary speed indicator (above or below 600 rpm) is supplied from the speed detector 93, described below.

Assuming the firing enable circuit 95A has enabled the timing logic 96A to initiate an ignition pulse, and that the four timing logic conditions noted above are met, including that either the advanced or retarded setpoints have been reached, then the Reset input the timing logic's SR latch 96A1 will switch to HI, thereby setting Q=LO which switches the timing logic's output from a HI to a LO.

The ignition coil firing circuit 94A uses an industry-standard 555 timer to generate a positive firing pulse of a duration set by the R30/C9 time constant. The 555 timer is triggered by a negative edge at its Trigger input which is the aforementioned HI to LO transition received from the SR latch 96A1 of the timing logic, and the resulting output of the 555 timer goes HI until the Threshold input rises to 0.67*5V (3.35v). The firing circuit 94A further includes a Darlington, push-pull, or other suitable high gain driver to switch on the power transistor QA for the duration of the 555 timer's output pulse. This pulse width may be set according to the magnetics of the power coils 68 so that, for example, they become saturated by the time the pulse ends and the current flow is interrupted.

The 555 timer's output also returns a signal to the firing enable circuit 95A to reset the SR latches' outputs to HI so that the 555 timer's Trigger input does not stay LO. Also, the 555 timer energizes the U1 and U2 opto-isolators of the power circuit 80 to prevent excessive dv/dt after ignition.

The speed detector 93 also uses a 555 timer, as well as a D-type flip-flop (DFF), and a transistor switch Q2A circuit operating the normal mode opto-isolators U3-U8 of the power circuit 80. The speed detector 93 comprises timer and logic circuitry that controls advancing and retarding of the ignition timing relative to an output of the position sensor 66 that is representative of an engine piston being at top dead center (TDC). The speed detector's 555 timer is connected in a one-shot configuration per its datasheet. The speed detector 93 takes as input one of the angular position sensor 66 derived state signals, SIN_{>}+0.3. To understand how the speed detector 93 works, assume its timer starts in standby state (OUT and DISCH are LO, RES and TRIG are HI) and speed detector output is LO (meaning below 600 rpm). Because the one-shot timer is set to 50 ms (one-half of a revolution at 600 rpm), the output will remain HI for a minimum of one-half of one revolution at 600 rpm.

The output of the speed detector's timer is wired to the input of the D-flip-flop (DFF). The output of the DFF is the speed range or state, used to indicate the operating mode of the power circuit 80 (startup or normal). The DFF clock is HI when the SINE input is below −0.3, one half-revolution after the timer starts when SINE falls below +0.3.

The speed detector timer triggers when the position sensor 66 SINE output rises above +0.3 (17.5°), as indicated by the SIN_{>}+0.3 signal. The timer resets (output goes LO) after 50 ms. The clock for the DFF transitions to HI when SINE is greater than −0.3 (197.5°), one half-revolution after the timer starts, as indicated by the SIN_{<}−0.3 signal. If the half-revolution is complete before the timer resets, then this indicates engine speed is above 600 rpm, and the speed detector state is set to HI, placing the power circuit 80 into the high-speed mode, such that sparks are triggered at the advance setpoint. Otherwise, the speed detector output remains in the LO state, maintaining the power circuit 80 in the low-speed mode, such that sparks are triggered at the retard setpoint.

As will be appreciated, the 600 rpm switchover point between low and normal mode operation is just one of numerous predetermined speeds that can be used. Also, the timing can be adjusted differently than just between the two firing angles discussed above. Different firing angles and engine speed ranges can be used; for example, in some embodiments at startup speeds under a predetermined speed that is within the range of 250-600 rpm, a first firing angle of about 0-10° after TDC is used and above that predetermined speed are the normal engine operating speeds for which a second firing angle of about 18-28° before TDC is used.

In yet other embodiments, the ignition timing can be adjusted more finely, providing anywhere from a continuously-variable timing to finer (>2) bands of engine speeds than the two ranges typically provided by mechanical magnetos. With additional sensor input, the timing can be adjusted based not only on engine speed, but for other factors affecting combustion, such as engine load, engine temperature, throttle position, atmospheric conditions (pressure, temperature, altitude, and/or humidity), air/fuel mixture, and combustion chamber size and/or design.

When installing the magneto in an engine, the fully electronic magneto 24 must be synchronized with the angular position of the crankshaft. This can be done with a timing light using the marks on the flywheel where the propeller is mounted. Coarse magneto synchronization can be achieved by turning the external drive gear 40 on the rotor to the correct position before meshing it with the engine's internal gear during mounting, and then fine adjustment to the correct synchronization can be done by slight rotational adjustments to the magneto housing 30 prior to tightening it down.

As discussed above in connection with FIG. 6, the discharge circuit 100 is a two channel CDI circuit that includes the TC3 tank (storage) capacitor which is charged via the red, grey, and black outputs from the power circuit 80, and includes the Channel A and B ignition coils 72 which are configured as step up transformers having a primary and an inductively coupled secondary connected to the high voltage terminals 36 of the magneto 24, to which are connected ignition leads 71 that route the ignition pulses to the spark plugs 70. The discharge circuit 100 further includes the two channels' solid state transistor switches QA, QB, wherein each channel's transistor and ignition coil primary are series connected in circuit across the tank capacitor TC3 such that, upon activation of the transistor, charge from TC3 flows through the transistor and primary thereby establishing a magnetic field that remains until the transistor is deactivated, at which time current flow through the primary is interrupted so as to induce a high voltage pulse across the secondary that is fed to the associated spark plugs 70 via the ignition leads 71.

The ignition system described above may be adapted for non-aviation uses, such as in small engines used for residential and commercial equipment that include at least one spark plug. For such purposes, the rotor 52 and power coil(s) 68 can be changed to increase or decrease the number of magnetic poles and coils, and suitable changes to the power and control circuitry 80, 90 can be made to adjust the timing and number of high voltage outputs for the intended application. Such modifications will be apparent to those skilled in the art.

It will of course be understood that the designations of various circuits, such as the power circuit and control circuit 80, 90, are logical constructs for aid in understanding the various functional parts of the overall ignition circuit 64, but that these functional portions of the ignition circuit 64 can be physically separate within the magneto 24 or can be partially or wholly integrated together.

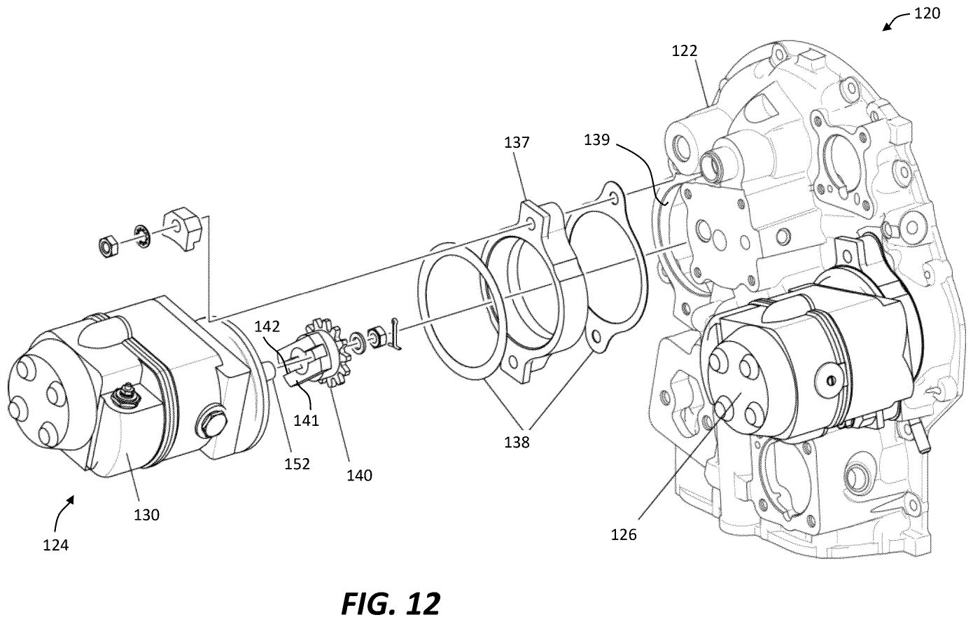

FIGS. 12-25 illustrate a second embodiment of a fully electronic magneto constructed in accordance with the invention. In these figures, elements corresponding to the same or similar elements of the first embodiment of FIGS. 1-11 are denoted by reference numerals increased by 100; thus, for example, aircraft piston engine 120 of FIG. 12 corresponds to piston engine 20 of FIG. 1. Elements of the second embodiment of FIGS. 12-25 can have the same construction and operation as the corresponding elements of the first embodiment unless shown or described differently or unless inherently requiring differences based on the description herein.

In FIG. 12 there is shown a portion of a four cylinder aircraft piston engine 120, including the auxiliary housing 122 of the engine to which are affixed a pair of left and right fully electronic magnetos 124, 126 constructed in accordance with the second embodiment of the invention. The two magnetos can be identical and are provided for redundancy, with the left magneto 124 driving upper spark plugs in each of the four cylinders and the right magneto 126 driving lower spark plugs in each of those same cylinders. In this way, all cylinders can be operated on either one or both of the two magnetos. The construction and operation of the left magneto 124 will be described below, it being understood that the construction and operation of the right magneto 126 can be identical.

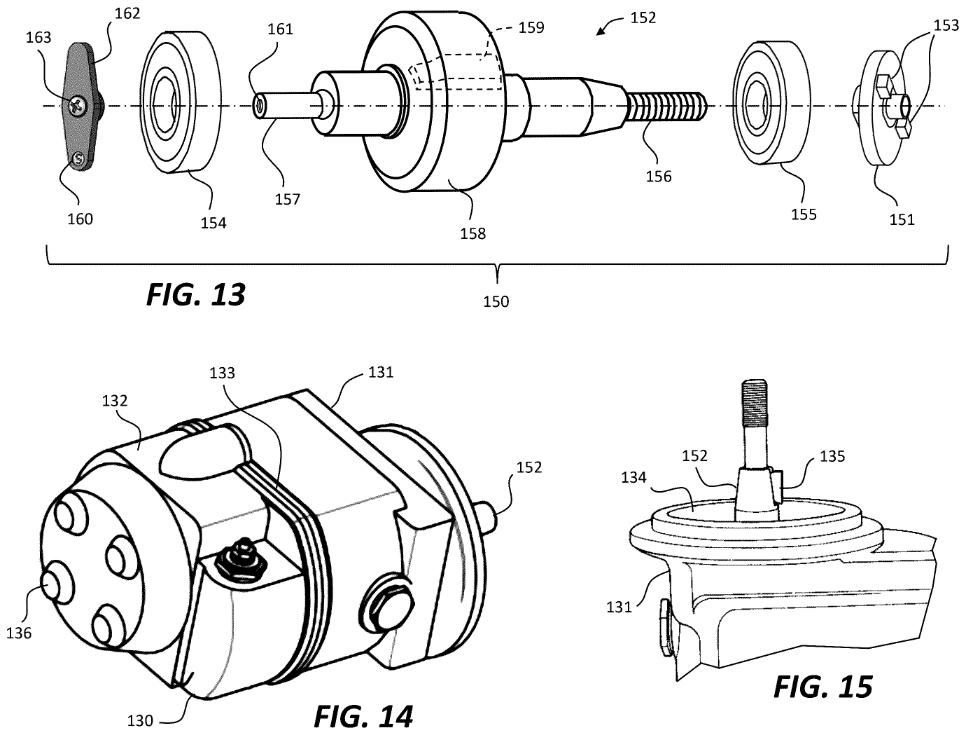

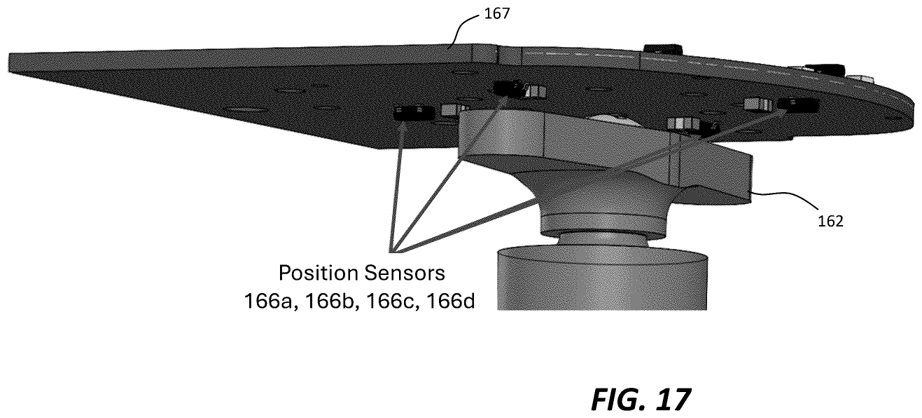

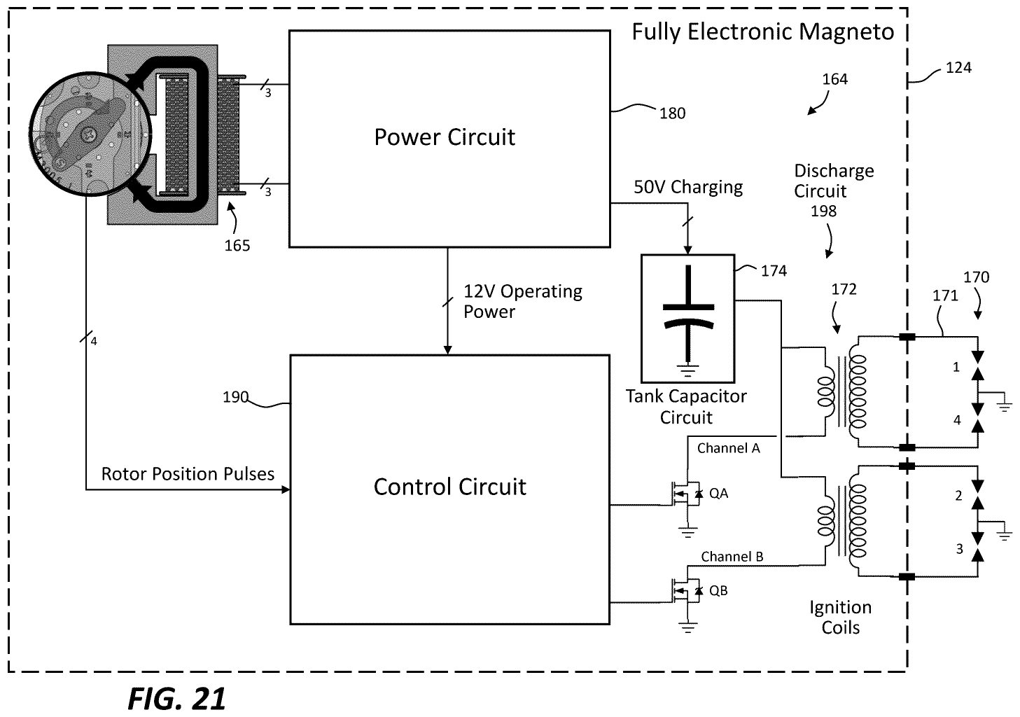

In general, the magneto 124 shown and described below comprises three main components or subassemblies: a housing 130, a magnetic rotor assembly 150 (FIG. 13), and an ignition circuit 164 (FIGS. 21-25). Unlike mechanical magnetos, the rotor 152 of the rotor assembly 150 is not used to actuate additional mechanical components in the internal ignition circuit. Instead, angular position sensors 166a, 166b, 166c, 166d (FIGS. 17, 18, 24) are used in combination with the rotating rotor 152 to determine rotor position and rotational direction, and from this, electronically develop the desired ignition timing to properly fire the engine spark plugs. As will be described below, this fully electronic magneto construction is made possible using a reconfigurable charging coil arrangement comprising multiple coils that are inductively powered off the magnetic rotor 152 and that are electronically reconfigurable from a higher turn power coil when running at low speeds into a lower turn power coil when running at higher speeds. This allows the magneto 124 to develop sufficient spark voltages even at low speeds without any external electrical power connection and without any impulse coupling or other mechanical approach to generating ignition energy. In the following description, the magneto housing 130, rotor assembly 150, power extraction, and rotor position sensing will be described, followed by the ignition circuit 164.

The magneto housing 130 holds and provides a sealed enclosure for the rotor assembly 150 and ignition circuit 164. As indicated in FIGS. 14 and 15, the housing 130 can be a two-piece housing having a lower frame 131 and an upper cap 132 that can be fastened to the frame 131 along a parting line 133. Removable fasteners such as screws or bolts or permanent fasteners such as rivets can be used for this purpose. The housing 130 has an opening 134 in its lower frame 131 through which the rotor 152 can be connected to the engine 120, with a Woodruff key 135, flat, or other means used to lock rotation of the rotor 152 to whatever drive component is used to mechanically power it. The housing 130 further includes four high voltage output terminals 136 mounted at an externally accessible location of the upper cap 132 to which ignition leads can be connected to deliver ignition impulses from the magneto 124 to the spark plugs (shown schematically in FIG. 21). The ignition leads and spark plugs can be conventional or otherwise.

Referring back to FIG. 12, the components of the mounting interface for the left magneto 124 to the engine 120 are shown in exploded view and include an adapter 137 and gaskets 138 to seal the opening 134 in the magneto housing to a corresponding opening 139 in engine auxiliary housing 122. This interface also includes an external drive component 140 in the form of an external gear having an integral hub 141 slotted on its front axial face with a drive slot 142 for transfer of rotational motion to an input coupling 151 (FIG. 13) of the rotor assembly. Although the external drive gear 140 fits over the input end of the rotor 152, it is external in that it is not part of the magneto, but is actually located within the engine auxiliary housing 122 in use. The drive gear 140 meshes with an upstream gear in the engine that is driven directly or indirectly off the crankshaft using a gear ratio that results in the external drive gear rotating at the same rate as the crankshaft. Thus, the rotational angle of the external drive gear matches that of the crankshaft position. FIG. 13 shows the mechanical input coupling 151 that can be rigidly affixed to the rotor 152 for rotation therewith. The input coupling includes drive lobes 153 keyed to mate with the drive slot 142 of the external drive gear 140 so as to provide positive driving engagement of the input coupling 151. In this way, the rotor 152 is driven directly by the external drive gear 140 such that rotation of the rotor is locked to that of the engine crankshaft.

This drive lobe/slot coupling for transmitting drive power to the rotor 152 is typical of mechanical magnetos in that it enables use of an impulse coupling for which the rotor is not locked to the external drive component, but is driven via a lobed coupling shell, and yet allows for non-impulse coupling magnetos to utilize the same slotted external drive component using a simple lobed input coupling that is locked to the rotor, such as shown in FIG. 13. However, for the fully electronic magneto 124 described herein, other simpler drive connections can be used, such as by securing the external drive gear 140 onto the rotor 152 in a locked manner that does not permit relative rotation between them. This provides a more direct drive of the magneto rotor using fewer parts.

The rotor 152 comprises a portion of the rotor assembly 150 that also includes at least one bearing, but typically both an inner bearing 154 and an outer bearing 155 as shown. These bearings 154, 155 are used for rotationally mounting the rotor 152 in the magneto housing 130. The rotor 152 includes the lobed mechanical input coupling 151 (shown in reverse perspective from the other components of FIG. 2). The rotor 152 extends from a first end 156 to a second end 157 and includes a permanent magnet assembly 158 at a location between the first and second ends 156, 157. The permanent magnet assembly 158 can be a conventional or unconventional arrangement of one or more magnets 159 that present one or more pairs of strong magnetic poles facing radially outwardly. These magnets 159 are referred to herein as power magnets since they are used in combination with the charging coil of the ignition circuit 164 to generate the electrical power needed to run and fire the spark plugs. The rotor 152 further includes a sensor magnet 160 that is carried by a rotor arm 162 secured by a screw 163 that threads into a threaded hole 161 located in the second end 157 of the rotor 152. The sensor magnet 160 is located near the end of one lobe of the rotor arm 162 so that it rotates about the rotor axis during operation. The rotor arm 162 includes an opposite lobe that provides weight symmetry to the rotor arm to avoid or at least minimize rotational imbalance during operation.

The rotor assembly 150 contains no impulse coupling, retard breaker, camshaft, cam, or distributor drive gear. Consequently, it is much simpler in design and construction than that used in mechanical magnetos. And, given that the rotor assembly does not drive motion of any further component in the magneto 124, it constitutes a “terminal mechanical device” which, as used herein, means a device that undergoes movement when mechanically driven without transferring any of the motion to another device. In other words, the rotor 152 rotates free of any mechanical loading, it being understood by those skilled in the art that the bearings 154, 155 holding the rotor 152 are not considered a mechanical load. The rotor assembly 150 is the last in the chain of mechanically driven components, which in this case also include, in driven order, the crankshaft, the internal engine gear(s) to the external drive component in the auxiliary housing 122, and the mechanical input coupling 151 of the rotor assembly 150.

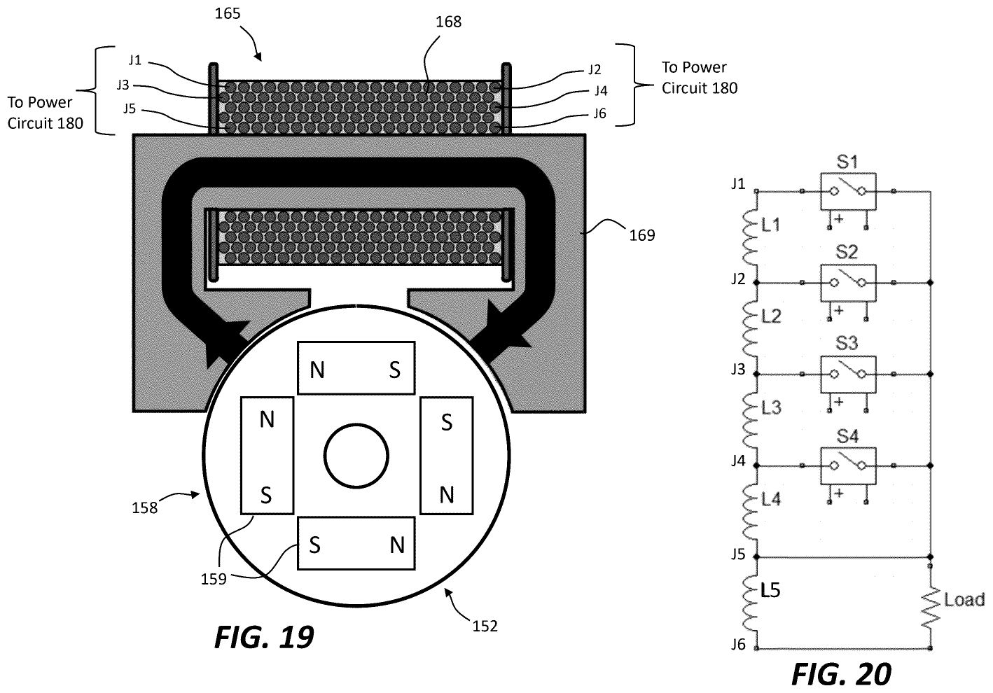

The elimination of an impulse coupling, retard breaker, camshaft, cam, contact breaker, and distributor is achieved by an innovative ignition circuit design that (i) is operated solely on electrical power produced internally within the magneto 124, (ii) includes an electronically reconfigurable charging coil 165 (FIGS. 19-21) that generates sufficient magneto power both at low (starting) engine speeds and at full engine speed, and (iii) is “fully electronic”, meaning that the ignition circuit 164 utilizes only non-mechanically actuated electrical components within the magneto 124 to generate and distribute the ignition pulses. This fully electronic ignition circuit 164 with its reconfigurable charging coil 165 allows for an ignition circuit in which, once the engine is started from a start motor, or even a proper manual turn of the propeller, ignition by the magneto 124 can begin even at engine speeds of about 100 rpm or less, and can continue throughout the entire range of engine speeds. And this fully electronic magneto 124 takes advantage of the fact that the mechanically-actuated circuit components in mechanical magnetos are all linked functionally to the need for control of the timing and distribution of the ignition pulses. In the illustrated embodiment, that ignition timing functionality is achieved electronically using four Hall effect sensors 166a-d (FIGS. 17, 18, 24) located adjacent the sensor magnet 160 of the rotor 152 to detect the instantaneous angular position of the rotor, and thus the engine crankshaft. As in the first embodiment, the distribution of the ignition pulses to the cylinders is achieved electronically using a plurality of ignition channels, each with its own ignition coil.

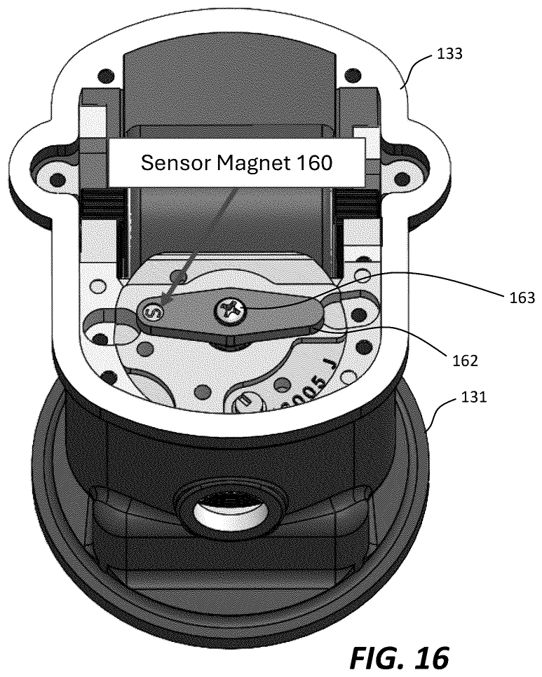

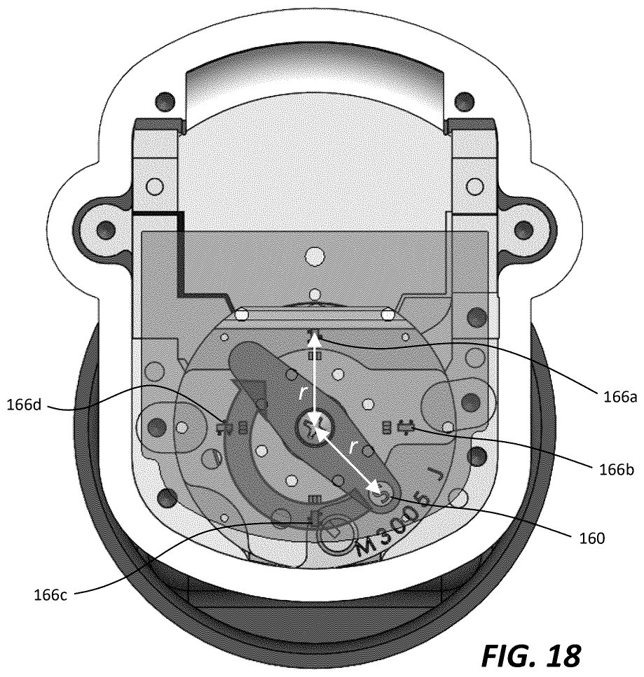

Referring now to FIG. 16, there is shown the magneto 124 with its upper cap 132 removed and showing the second terminal end of the rotor assembly where the rotor arm 162 is attached. As shown, the sensor magnet 160 is located at a fixed radial distance r from the rotational axis of the rotor assembly (i.e., the center of screw 163) such that it circumscribes a circular path of radius r when the rotor 152 rotates. When the magneto 124 is fully assembled, the position sensors 166a-d are located immediately adjacent the rotor arm 162 so as to sense the rotation of sensor magnet 160 around the circular path. As shown in FIGS. 17 and 18, this is accomplished by mounting the Hall effect position sensors 166a-d in quadrature on a sensor board 167 such that they are spaced from a common center point by the radius r. FIG. 18 depicts the sensor board 167 in phantom (partial transparency) to show the locations of the position sensors 166a-d relative to the sensor magnet 160. The sensor board 167 can be mounted to the housing 130 in the lower frame 131 above the rotor arm 162, or instead in the upper cap 132 such that it automatically aligns with the rotor arm 162 when the upper cap is secured to the lower frame.

As will be understood by those skilled in the art, the use of the four position sensors 166a-d, each spaced 90° from its adjacent sensor, allows both accurate rotor position determination (4 times per revolution) as well as directionality of that rotation-clockwise (CW) vs. counter-clockwise (CCW). Referring particularly to FIG. 18, it will be appreciated that when the rotor turns clockwise as shown by the rotational arrow, the sensor magnet 160 passes sequentially by each separate position sensor 166a-d in a particular order—166a, then 166b, then 166c, then 166d, and then back to 166a for the next revolution. If the rotor is turned counter-clockwise, this order is reversed. Thus, when connected in circuit and powered, each position sensor 166a-d will provide a signal as the sensor magnet 160 passes by, and the ignition circuit 164 can use this timing and order of pulses from the different sensors to determine rotor position (and thus crankshaft/cylinder position) as well as rotor speed and CW or CCW rotational direction.

Although the illustrated embodiment utilizes four position sensors, those skilled in the art will know of other arrangements using more or less sensors. Increased resolution of position and timing may be achieved by using more sensors, whereas using less sensors can decrease complexity and cost. Three sensors can be spaced equidistant about the rotational axis and used to determine position, speed, and rotational direction in the same way as described above. Two sensors, spaced around the circular path of sensor magnet rotation at other than 180° can also be used to determine position, speed, and rotational direction, but at a cost of accuracy.

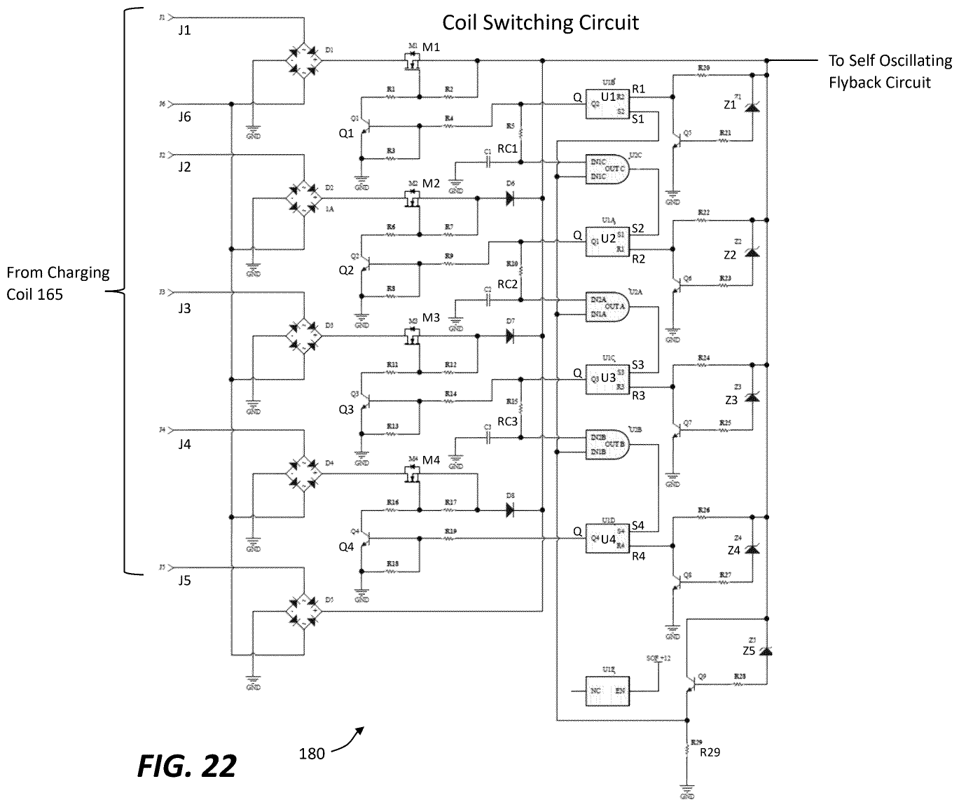

FIG. 19 shows diagrammatically the design of the reconfigurable charging coil 165 used to extract power from the rotating magnetic fields generated by the rotor 152. This charging coil 165 has both similarities and differences of the charging coil 65 used in the first embodiment. Whereas charging coil 65 is formed from four separate power coils 68 wound together on the core 69 and connected back to the power circuit 80, charging coil 165 can be implemented as a continuous winding running from lead J1 to lead J6 having four intermediate taps J2, J3, J4, J5 that are used for reconfiguring the coil 165 into five power coils 168 for purposes of powering the magneto 124. This four tap charging coil 165 can be implemented in a number of ways. For example, it can be made using a plurality of identical windings 168 in the same manner as done for charging coil 65 (but with five windings instead of four), with the end lead of each coil 168 being connected to the start lead of the next coil 168, and this connection can be done at the charging coil 165 or at the power circuit 180 (FIG. 22). Alternatively, a single uninterrupted winding can be used for charging coil 165 with the four taps taken off the single coil at equal points along its length to thereby effectively provide the power circuit 180 with access to the five separate power coils 168.

However constructed, the charging coil 165 is wound on a ferromagnetic core 169 positioned in the housing 130 adjacent the power magnets 159 of the rotor 152 to concentrate and guide the changing magnetic field lines that extend between opposite magnetic poles of the rotor 152 as the rotor spins. The instantaneous rotor position in FIG. 19 shows the rotor angle at which maximum flux occurs in the core 169. Magnet assembly 158 uses four magnets 159 arranged as shown which produces maximum flux through the core 169 at the position shown. As with the first embodiment, any magnets having suitable magnetic strength can be used, and this may include ALNiCo magnets, as are known, as well as neodymium magnets such as N52SH that are hermetically sealed, e.g., by nickel plating, to prevent corrosion. The magnetic field lines are shown in the aggregate with the direction of those fields lines from North to South indicated by the arrows. As the rotor continues to turn, the magnetic field will collapse to zero and then reverse direction and increase again to maximum flux as the rotor reaches 90° from the position shown. These rising and collapsing magnetic fields induce current flow through each of the five power coils 168, allowing them to be used in the ignition circuit 164 as five separate electrical sources that are summed together to generate a sufficient dc voltage and amperage to fire the engine spark plugs via the ignition coil.

As will be explained below, the use of the four taps of the charging coil 165 allows the power circuit 180 to effectively reconfigure the charging coil 165 from a higher winding (larger number of turns) into a smaller winding (less turns) as needed to maintain the proper voltage and power needed by the magneto to begin firing the spark plugs at 100 rpm and continue operating the spark plugs at maximum engine rpms. Thus, whereas the first embodiment configured the charging coil 65 from a series connection of the power coils 68 into a parallel connection at higher speeds, this second embodiment reconfigures the charging coil from a high turn coil (all five power coils in series) to a lower turn single coil at higher speeds, and this is done by removing individual ones of the power coils 168 from the power circuit when not needed.

FIG. 20 shows a logical representation of this approach, wherein one of the five power coils 168 (labeled L1, L2, L3, L4, L5) is used in all circumstances; that is, during all operation of the ignition circuit to power the magneto 124 (represented by the load), and the other four can be switched in and out of circuit to reconfigure the charging coil as needed to provide the needed voltage level for the magneto. For startup and low speed operation, all five power coils 168 are active in providing inductive power to the magneto and as the engine speed increases, individual coils can be switched out to prevent an overvoltage condition. This is done in order such that coil L1 is the first to be switched out of circuit, followed by coil L2, etc., such that coil L4 is the last to be switch out of circuit which may occur and very high engine speeds when coil L5 is sufficient alone to power the magneto and spark plugs. And, conversely, L4 is the first coil to be switched back into circuit when more voltage is needed, and L1 is the last. The implementation of this operation of the power circuit 180 will be better understood by the description further below and review of FIG. 22.

As in the first embodiment, these five power coils 168 can be electronically configured by the ignition circuit 164 into different combinations of contributions to the powering of the magneto. This enables self-powering of the magneto 124 across the full range of engine speeds, from startup to maximum rpm. All without the need for an external power supply connection and without the use of extra mechanical components.

Turning now to FIGS. 21-25, the ignition circuit 164 will now be described. FIG. 21 is a functional block diagram view of the ignition circuit 164 of the fully electronic magneto 124 and is shown connected to four spark plugs 170 by ignition leads 171. The ignition circuit 164 includes the position sensors 166a-d and the reconfigurable charging coil 165 from which the ignition circuit 164 obtains only magnetic field inputs, and only from the rotating magnetic rotor 152. One magnetic input is the reversing magnetic field from the power magnets 159 and the other magnetic input is from the position sensor magnet 160. The ignition circuit 164 is logically and (mostly) physically separated into three main circuits-a power circuit 180, a control circuit 190, and a discharge circuit 198. The power and control circuits 180, 190 are implemented on separate printed circuit boards (PCBs) mounted in the housing 130, and the discharge circuit 198 is mostly separately packaged components, also mounted in the housing. The circuit boards and discrete discharge circuit components are interconnected by soldered wiring running between them.

In general, power is extracted by the charging coil 165 that is made up of the five power coils 168 (L1-L5). This extracted power is induced in the power coils 168 from the changing magnetic field lines produced by the rotor 152 during rotation. These coils 168 form a part of the power circuit 180, but are located adjacent the rotor 152 for inductive coupling. The power circuit 180 uses the induced current from the coils 168 to charge one or more tank (or storage) capacitors in a tank capacitor circuit 174. This stored charge from the tank capacitor circuit 174 provides the electrical power needed to operate the control circuit as well as providing the energy needed by the discharge circuit to fire the spark plugs 170. For a four stroke, four cylinder engine with two pairs of identically timed pistons (i.e., having the same TDC) that are reciprocating together at 180° or other angle relative to the other pair, the ignition circuit 164 can be configured as shown to run in a wasted spark configuration, with cylinders 1 and 4 firing together (as well as cylinders 2 and 3 firing together) even though one of each pair of cylinders is near TDC between exhaust and intake strokes, rather than between the compression and power strokes. This allows the ignition system to run with only two channels A and B using only two ignition coils 172 that have the different ends of their secondary connected to a different spark plug 170 in a different one of the two cylinders in the pair.

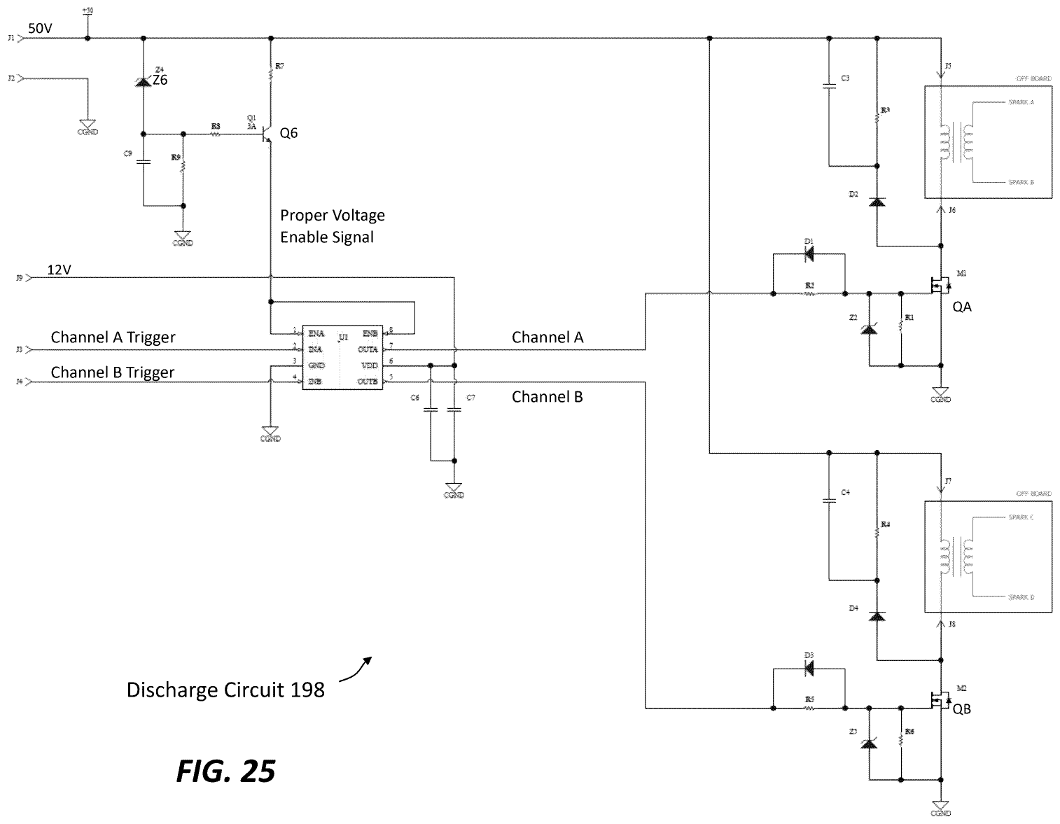

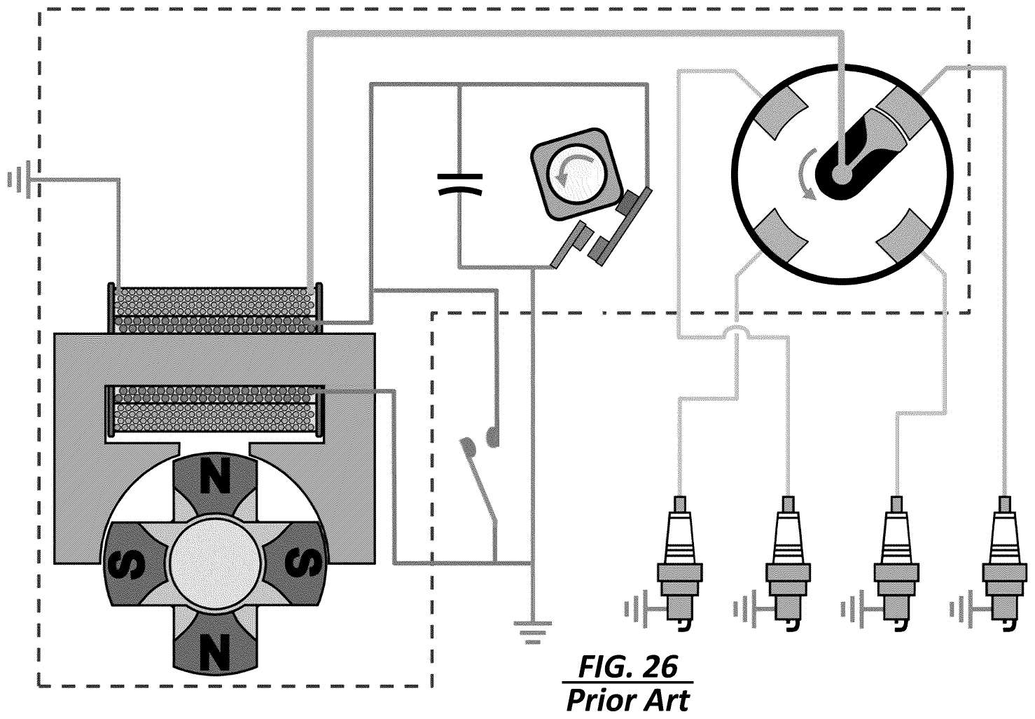

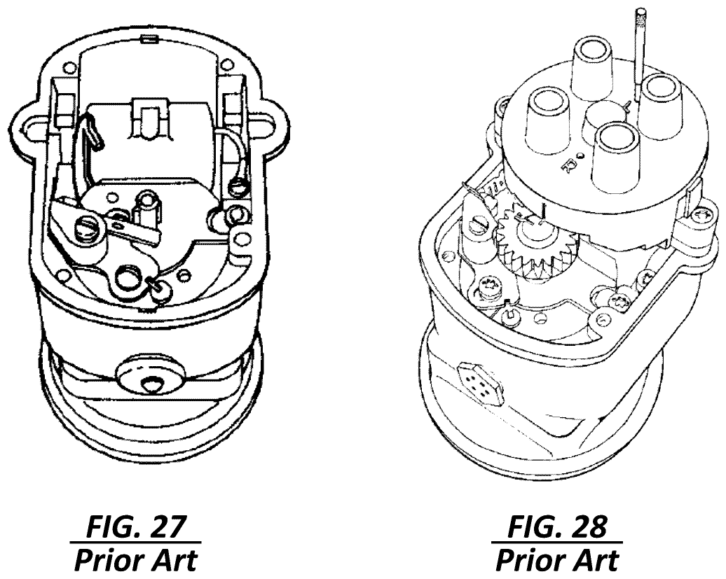

Although various spark generation circuits may be used, the illustrated embodiment uses a capacitive discharge ignition (CDI) scheme wherein the charge stored in the tank capacitor circuit 174 is drawn through the primary of the ignition coils 172 by power transistors QA and QB (FIGS. 21 and 25) and then suddenly interrupted by switching off the transistors, thereby causing a large voltage across the secondary of each ignition coil, as is known. This is discussed farther below in connection with the construction and operation of the discharge circuit 198.

Sufficient electrical power for the ignition circuit 164 and sparking of the plugs can be achieved at both startup and normal speeds without a separate electrical source by using the plurality of power coils 168 wrapped on the core 169, whether side-by-side or overlapping, with the coil outputs being summed together to develop sufficient voltage and current for charging the tank capacitor circuit 174 to the voltage needed to ignite the spark plugs 170 via the ignition coils 172. In the illustrated embodiment, five power coils 168 are used to generate this charging current using a reconfigurable charging coil approach that sums or superimposes the coils' voltages at low speeds and selectively, functionally removes coils from the circuit at higher speeds. Although five coils are used in the embodiment shown, other embodiments may use more or less power coils as desired or needed for a particular application.

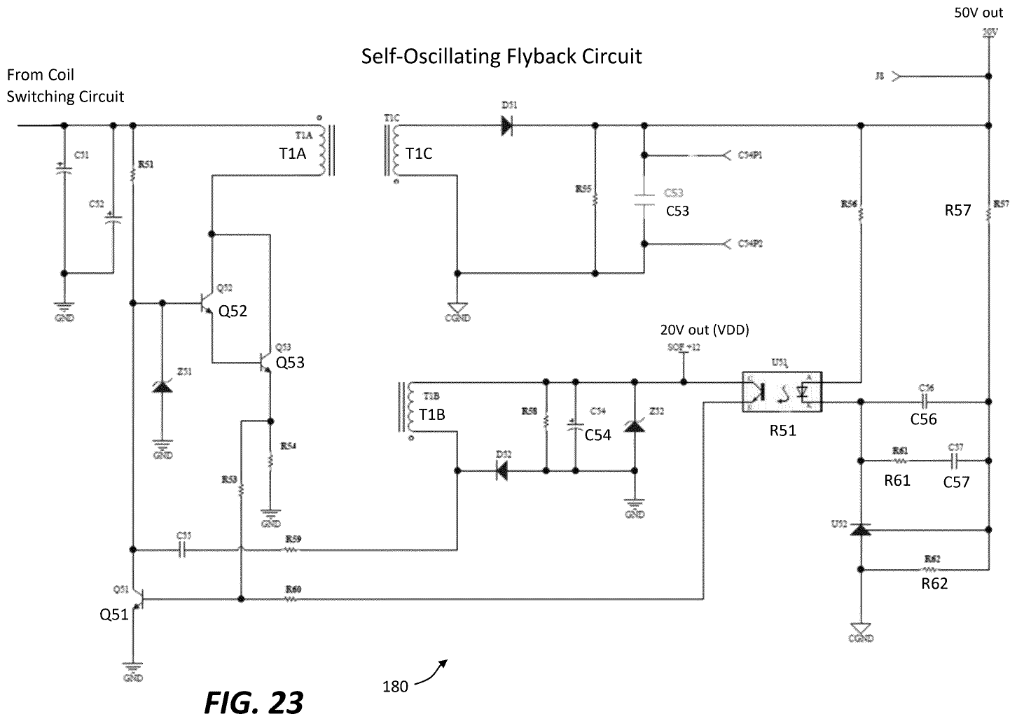

Tank capacitor circuit 174 may be implemented using multiple capacitors, as with the tank capacitor circuit 74 of the first embodiment. However, in the second embodiment, a single tank capacitor C53 of sufficient capacity (FIG. 23) is used.

FIGS. 22 and 23 together depict the power circuit 180. It is a mostly analog circuit that includes the five power coils 168 from charging coil 165 along with a coil switching circuit (FIG. 22) and a self-oscillating flyback circuit (FIG. 23). The coil switching circuit receives as inputs the AC power from the five power coils 168, rectifies then to DC using full wave bridge rectifiers, monitors their combined, or summed, voltages and then switches individual power coils into and out of operation (contribution) depending upon whether the combined voltage is above or below a desired range needed by the self-oscillating flyback circuit to generate the 12v and 50v supply voltages. This switching of coils into and out of the circuit is done using four MOSFET switches M1-M4 with corresponding SR latches U1-U4 that control the switches M1-M4, respectively. The fifth power coil 198 is permanently connected to supply power such that it cannot be switched out of contribution to the operating power.

Depletion mode MOSFETS are used for M1-M4. This has the advantage that, upon startup, where no power is yet present, all four switches M1-M4 will conduct as rectified power comes in from the power coils 165. Initially, the voltage through the switches M1-M4 will combine together at the common output node connected to the self-oscillating flyback circuit. This node is also connected to the reset inputs of each SR latch U1-U4. Thus, at startup, each latch is reset to a zero (ground) output, causing the associated transistor Q1-Q4 to remain off, which continues to allow their associated switches M1-M4 to conduct. Once the output node increases in voltage to a value above the Zener breakdown voltage for corresponding diodes Z1-Z4, the transistors at the reset inputs to the U1-U4 latches are turned on, grounding the reset inputs to U1-U4 setting them in a latching mode with their Q outputs still at zero allowing the switches M1-M4 to continue to conduct.

This use of all five power coils at startup allows the circuit to provide sufficient voltage and power to operate the magneto and ignite the spark plugs at rpms as low as 100. To protect against overvoltage, the coil switching circuit includes an overvoltage circuit comprising the Zener diode Z5, the latches U1-U4, three AND gates, and three RC charging circuits. Zener diode Z5 has a reverse breakdown voltage greater than any of Z1-Z4 and is selected so that the voltage at the output node does not exceed the voltage desired to operate the self-oscillating flyback circuit. If the voltage at the output node (i.e., at Z5) exceeds its breakdown voltage, it will conduct, turn on its associated transistor, which provides logical high voltage across resistor R29 which is provided to the set input of latch U1, thereby switching its Q output to a logical high voltage, thereby turning on transistor Q1 which switches the gate of M1 to ground, thereby providing a negative Vas to M1 which stops its conduction of power from its bridge rectifier and effectively removing it from the power circuit 180. As a result, the output node voltage will decrease.

Assuming the output node voltage decreases enough to fall below the breakdown voltage of Z5, that diode will switch back off its associated transistor, bringing the U1 set input back to ground. It will also disable any change to the already zero outputs of the other latches U2-U4 by virtue of its input to the AND gates that control the set inputs of U2-U4.

In the event the output node voltage does not decrease below the breakdown voltage of Z5, the second power coil will then be switched out of the circuit. This occurs using the RC1 time constant circuit that charges from the output of latch U1. Since Z5 remains conducting and providing a logical high at the one input of each AND gate, then the eventual charging of RC1 to a logical one will cause the first AND gate output to go high, thereby causing the second latch U2 to bet set by its S2 set input. This same process will continue with latches U3 and U4 using the second and third RC circuits and AND gates until the output node voltage falls enough to stop Z5 from reverse breakdown.

Conversely, once one or more of the switches M1-M4 have been turned off, if the output voltage then falls below a desired value, the switches will be turned on, one at a time, until the output node voltage increases to the desired level. This is done using an undervoltage circuit that includes the latches U1-U4 and their associated Zener diodes Z1-Z4. These Zeners are selected to have increasing breakdown voltages that are all below that of Z5. Thus, the breakdown voltage of Z1 (V_{BrZ1})<(V_{BrZ2})<(V_{BrZ3})<(V_{BrZ4})<(V_{BrZ5}). For example, if switches M1 and M2 have been turned off due to overvoltage occurring at the output node, and the output voltage subsequently falls below V_{BrZ4} and then V_{BrZ3}, their Zeners Z4, Z3 will stop conducting in that order. The output node voltage will thus provide a logical high to the reset inputs R3, R4 of latches U3, U4. Since these latch outputs are already at a logical zero (M3 and M4 are switched on), no change occurs. If the voltage continues falling and goes below V_{BrZ2}, Z2 will stop conducting such that its latch U2 reset input R2 will receive a logical high voltage and thereby reset its Q output to a logical zero, which turns back on switch M2. This will then begin to increase the output node voltage. If nonetheless the voltage continues to drop (e.g., due to a reduction in engine speed), then the output voltage falling below VBrz will cause Z1 to stop conducting and M1 to switch back on.

In this way, the coil switching circuit provides regulation of the voltage coming from the charging coil 165 across a large range of voltages.

Turning now to FIG. 23, the self-oscillating flyback circuit receives the output node voltage from the coil switching circuit and generates the 50V power used to charge the tank capacitor C53, and generates the 12V power (VDD) used to run the other ignition circuit 164 components. This circuit topology allows for operation of the circuit at a minimum input of 2V to a maximum input of 47V received by the coil switching circuit. The construction and operation of self-oscillating flyback circuits is known to those skilled in the art, so only a brief description of the relevant features of the circuit are included here.

The main transformer consists of a primary (T1A), secondary (T1C), and tertiary windings (T1B). T1C and T1B are sized to reach 50V and 12V respectively based on their ratio of turns between one another. A simple voltage divider (R57 and R62) is used to detect when 50V has been reached. Upon reaching this value, current is pulled through the internal LED of opto-isolator U51. This internal LED will turn on the internal transistor which turns on Q51, thereby shutting off the Darlington Configuration Q52/Q53. Capacitors C56, C57, and resistor R61 are placed to help with the stability of the circuit through multiple transient scenarios that can occur while operating in a continuously fluctuating environment.

C53 represents the tank capacitor that stores the required energy to deliver 34mJ minimum to the spark plugs. C54 is used to help control voltage dips while the internal components are consuming what little power they need to operate.

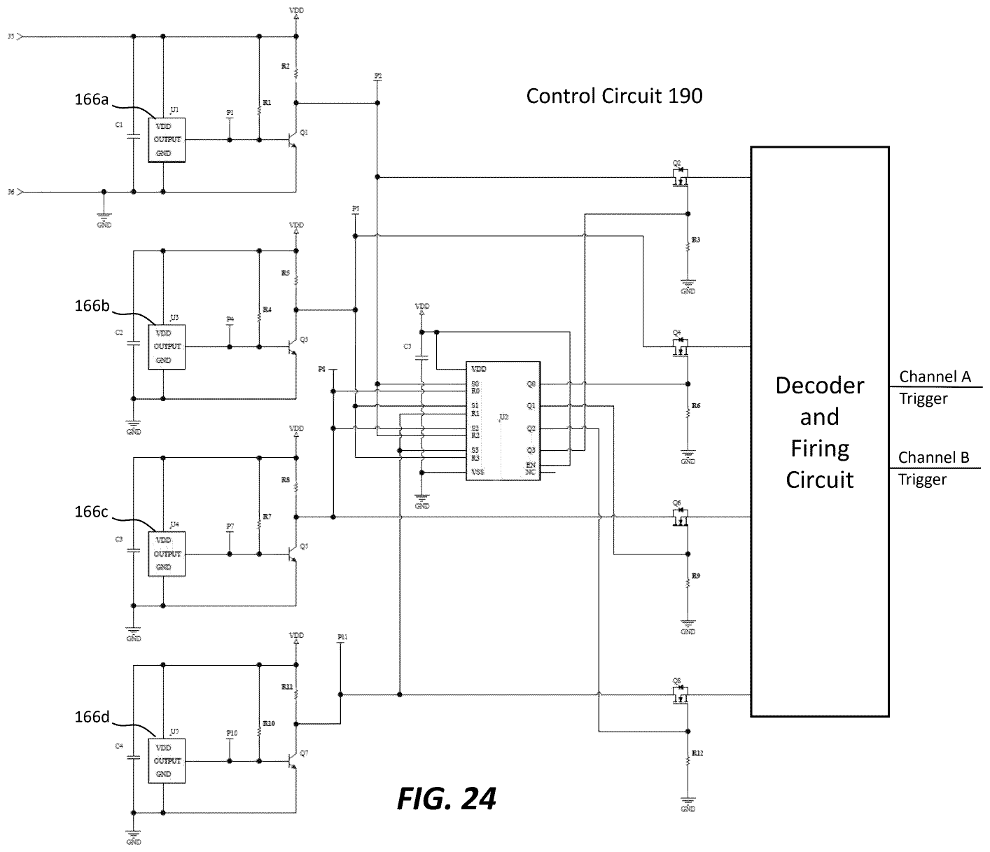

FIG. 24 depicts the control circuit 190 that receives the inputs from the four Hall effect position sensors 166a-d and outputs trigger signals to the discharge circuit 198 of FIG. 25. The sensor outputs are provided to SR latches in the manner shown in FIG. 24 which are used to control MOSFET switches that provide four input pulse signals representing the sequence and timing of the sensor pulses. These are used by a decoder/firing circuit that generates trigger signals for each of the two ignition output channels A and B only if the correct direction of rotation is indicated (CW rather than CCW) and with an ignition pulse width and timing desired for firing of the spark plugs. The processing of the input pulse signals for directionality of rotor rotation and the timing and duration of the trigger pulses will be apparent to those skilled in the art.

FIG. 25 shows the discharge circuit 198 which is fundamentally the same as discharge circuit 98 of the first embodiment. Circuit 198 includes a Zener diode Z6 that controls a transistor Q6 to enable firing only if there is sufficient 50v voltage present from the power circuit 180. This enable signal is provided to the driver as a gating of the Channel A and B Trigger signals from the control circuit 180.

The additional aspects of changing timing of the sparks based on engine speed (e.g., above or below 600 rpm) that are discussed above in connection with the first embodiment can all be utilized in implementation of this second embodiment, and such implementation will be apparent to those skilled in the art.

The ignition system described above may be adapted for non-aviation uses, such as in small engines used for residential and commercial equipment that include at least one spark plug. For such purposes, the rotor 152 and power coil(s) 168 can be changed to increase or decrease the number of magnetic poles and coils, and suitable changes to the power and control circuitry 180, 190 can be made to adjust the timing and number of high voltage outputs for the intended application. Such modifications will be apparent to those skilled in the art.

It will of course be understood that the designations of various circuits, such as the power circuit and control circuit 180, 190, are logical constructs for aid in understanding the various functional parts of the overall ignition circuit 164, but that these functional portions of the ignition circuit 64 can be physically separate within the magneto 124 or can be partially or wholly integrated together.

The foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An aircraft piston engine magneto having a magnetic rotor and an ignition circuit that includes a charging coil inductively coupled to magnetic poles of the rotor, wherein the charging coil comprises a plurality of power coils that are inductively powered off the magnetic rotor and that charge the ignition circuit during rotation of the rotor, and wherein one or more of the power coils are electronically utilized by the ignition circuit as a higher turn power coil when the rotor is running at low speeds and as a lower turn power coil when the rotor is running at higher speeds.

2. The magneto of claim 1, wherein the ignition circuit comprises a power circuit that includes the power coils and wherein the ignition circuit utilizes all of the power coils at low speeds and functionally removes one or more of the power coils from the power circuit at higher speeds.

3. The magneto of claim 2, the ignition circuit functionally removes all but one of the power coils when the rotor is running at or near a maximum rotor speed.

4. The magneto of claim 1, wherein one of the power coils is used during all operations of the ignition circuit to power the magneto.

5. The magneto of claim 1, wherein only one of the power coils is used during all operations of the ignition circuit to power the magneto and wherein the other power coil(s) are switched in and out of circuit as needed to provide sufficient power to operate the magneto.

6. The magneto of claim 1, wherein the charging coil comprises a continuous winding having a start lead and an end lead and one or more intermediate taps, wherein each separate portion of the charging coil between different taps and/or leads comprise a different one of the power coils.

7. The magneto of claim 6, wherein the continuous winding comprises a plurality of separate windings connected in series by having an end lead of each separate winding electrically connected to a start lead of a successive one of the separate windings.

8. The magneto of claim 1, wherein the ignition circuit includes a separate rectifier for each of the power coils and includes an associated transistor for each of at least some of the rectifiers, wherein each of the transistors is connected to receive dc power from its associated rectifier, and wherein the transistors are depletion mode transistors connected in circuit such that, upon startup of the ignition circuit, the transistors will conduct through the transistor the dc power received from its associated rectifier.

9. The magneto of claim 8, wherein the ignition circuit further comprises, for each of the transistors, a separate latch configured to control its associated transistor by switching the transistor on or off based on a voltage level within the ignition circuit.

10. The magneto of claim 9, wherein the latches are controlled using an overvoltage circuit and an undervoltage circuit that both control each separate latch based on a set voltage that is different from the set voltages used by the other latches.

11. The magneto of claim 10, wherein the set voltages are determined by Zener diodes.

12. The magneto of claim 1, wherein the charging coil is configured into the higher turn power coil by electronically connecting the plurality of power coils in series, and is configured into the lower turn power coil by electronically connecting the plurality of power coils in parallel.

13. The magneto of claim 1, wherein the magneto comprises a housing, wherein the magnetic rotor and ignition circuit are mounted in the housing, wherein the ignition circuit includes high voltage output terminals mounted at an externally accessible location of the housing, and wherein the ignition circuit is a fully electronic ignition circuit that generates and distributes ignition pulses to the output terminals using only non-mechanically actuated electrical components within the magneto.

14. The magneto of claim 1, wherein the magneto comprises a housing and a rotor assembly comprising the magnetic rotor and at least one bearing that supports the rotor for rotation in the housing, and wherein the rotor assembly is a terminal mechanical device such that the rotor rotates within the housing without transferring its mechanical motion to any of the circuit components.

15. A magneto comprising:
a housing;
a rotor assembly mounted in the housing and comprising a magnetic rotor and at least one bearing that supports the rotor for rotation in the housing about a rotational axis, the rotor assembly having a first end and a second end, with the rotor having a permanent magnet assembly located between the first and second ends, and with the rotor having a rotor arm fixed to the rotor at the second end of the rotor assembly, the rotor arm carrying a sensor magnet located at a radial distance from the rotational axis such that the sensor magnet circumscribes a circular path about the rotational axis when the magnetic rotor rotates, and wherein the first end of the rotor assembly is externally accessible at an opening in the housing such that the rotor can be rotationally driven by an external drive component; and
an ignition circuit comprising circuit components that include a plurality of magnetic field sensors and at least one power coil inductively coupled to the permanent magnet assembly of the magnetic rotor, the ignition circuit including high voltage output terminals mounted at an externally accessible location of the housing;
wherein the rotor assembly is a terminal mechanical device such that the rotor rotates within the housing without transferring its mechanical motion to any of the circuit components; and
wherein the plurality of magnetic field sensors are positioned adjacent the rotor arm at separate locations corresponding to the radial distance of the sensor magnet from the rotational axis of the rotor whereby, during rotation of the rotor arm by the rotor, the magnet sequentially passes by each of the magnetic field sensors.

16. The magneto of claim 15, wherein the ignition circuit is a fully electronic ignition circuit that generates and distributes ignition pulses to the output terminals using only non-mechanically actuated electrical components within the magneto.

17. The magneto of claim 15, wherein each of the magnetic field sensors provide a signal pulse output when the magnet passes by the sensor, and wherein position, speed, and rotational direction of the rotor can be determined from the signal pulse outputs of the sensors.

18. The magneto of claim 17, wherein the plurality of magnetic field sensors comprises two magnetic field sensors spaced about the circular path at other than 180° apart.

19. The magneto of claim 17, wherein the plurality of magnetic field sensors comprises three or more magnetic field sensors and wherein the ignition circuit determines one or more of the position, speed, and rotational direction of the rotor from the signal pulse outputs of the three or more magnetic field sensors.

20. The magneto of claim 19, wherein the magnetic field sensors are spaced equidistant from each other about the rotational axis of the rotor.

21. The magneto of claim 19, wherein the position of the rotor is can be determined from the signal pulse output of any single one of the magnetic field sensors, the speed of the rotor can be determined from the timing of signal pulse outputs of at least two of the magnetic field sensors, and the direction of rotation of the rotor can be determined from the order of signal pulse outputs of at least two of the magnetic field sensors.

22. The magneto of claim 19, wherein the plurality of magnetic field sensors comprises four magnetic field sensors mounted in quadrature about the rotational axis, wherein the position of the rotor is supplied by the signal pulse outputs to the ignition circuit four times per revolution of the rotor.

23. The magneto of claim 15, wherein the magnetic field sensors are mounted on a circuit board oriented perpendicular to the rotational axis and positioned immediately adjacent the rotor arm.
